(19) United States
(12) Patent Application Publication
(10) Pub. No.: US 2018/0367626 A1
(43) Pub. Date: Dec. 20, 2018

(54) AUTOMATIC DIGITAL MEDIA INTERACTION FEEDBACK

(71) Applicant: Get Attached, Inc., New York, NY (US)

(72) Inventors: Albert Azout, Palo Alto, CA (US); Douglas Imbruce, New York, NY (US); Jackson Deane, New York, NY (US); Gregory T. Pape, New York, NY (US)

(21) Appl. No.: 15/627,072

(22) Filed: Jun. 19, 2017

(51) Int. Cl. H04L 29/08; G06F 3/0484; G06F 3/0485; G06F 3/01; G06F 17/30; G06Q 50/00

(52) U.S. Cl. CPC H04L 67/26; H04L 67/22; G06F 3/04842; G06Q 50/01; G06F 3/013; G06F 17/30274; G06F 3/0485

(57) ABSTRACT

At a device of a first user, a digital media associated with a second user is received. It is detected that the device has displayed the digital media. It is determined whether the device has displayed the digital media for at least a threshold amount of time. In an event the device has displayed the digital media for at least the threshold amount of time, an indication is provided to the first user and a notification is sent. The notification is utilized to provide to the second user, information associated with an interaction by the first user with the digital media.

### BACKGROUND OF THE INVENTION

Traditional digital media sharing applications present a user with a collection of shared photos to view. Often the user is presented with a collection with dozens or more photos for viewing. Typically the user views the shared photos one at a time by scrolling to advance the photos sequentially. The scrolling speed for touch input devices is typically limited to prevent a user from accidentally scrolling past desired content. For example, a user performs a swipe gesture to scroll from one full sized photo to the next. Scrolling in this manner can be an inefficient and tedious process that may discourage and impede sharing of important captured moments that the user would have otherwise liked to view. For example, a user may miss an important photo that is part of a collection of photos if the photo is buried too deep in the collection and requires too much effort to advance to that photo. Additionally, this digital computer interface problem cannot be simply addressed by increasing scroll speed. For example, users may also miss desired content by advancing too quickly. From a sharing perspective, users may also be discouraged from sharing digital content when the shared digital content is accidentally missed by the recipient due to these user interface limitations.

When presented with a collection of shared photos to view in a traditional digital media sharing application, typically the user browses through the shared photos and after viewing a photo may comment on or identify the photo as one of his or her favorites. Providing feedback after viewing the photo promotes sharing and interaction but manually providing feedback can be a tedious process and does not capture the engagement a user has while viewing the shared media. The effort required to leave feedback after viewing the media may discourage interaction between users as a result of the inefficiencies in the technical implementation of computer user interfaces that slow and impede interaction. For example, many users may be interested in a shared photo but unless users manually comment on the photo, users may be unaware of each other's interest in the media. Users also may be unaware of a photo that others find interesting in the event the photo has little or no feedback. Additionally, if a digital media that is desired by its owner to be not shared is accidently shared (e.g., due to a technical or user error), it is desirable for the owner to be informed about the degree to which others have accessed the digital media.

### BRIEF DESCRIPTION OF THE DRAWINGS

Various embodiments of the invention are disclosed in the following detailed description and the accompanying drawings.

FIG. 1 is a block diagram illustrating an example of a communication environment between a client and a server for sharing and/or accessing digital media.

FIG. 2 is a functional diagram illustrating a programmed computer system for sharing and/or accessing digital media in accordance with some embodiments.

FIG. 3 is a flow diagram illustrating an embodiment of a process for automatically sharing desired digital media.

FIG. 4 is a flow diagram illustrating an embodiment of a process for classifying digital media.

FIG. 5 is a flow diagram illustrating an embodiment of a process for the creation and distribution of a machine learning model.

FIG. 6 is a flow diagram illustrating an embodiment of a process for automatically sharing desired digital media.

FIG. 7 is a flow diagram illustrating an embodiment of a process for applying a context-based machine learning model.

FIG. 8 is a flow diagram illustrating an embodiment of a process for advancing digital media by an amount corresponding to a magnitude value.

FIG. 9 is a flow diagram illustrating an embodiment of a process for advancing digital media based on gradient properties.

FIG. 10 is a flow diagram illustrating an embodiment of a process for automatically providing digital media feedback.

FIGS. 11A, 11B, and 11C are diagrams illustrating embodiments of a user interfaces for digital media browsing and feedback.

FIG. 12 is a diagram illustrating an embodiment of a user interface for providing digital media feedback.

FIG. 13 is a diagram illustrating an embodiment of a user interface for digital media browsing and feedback.

FIG. 14 is a diagram illustrating various embodiments of user interface browsing indicators for digital media browsing and feedback.

FIGS. 15A and 15B are diagrams illustrating embodiments of user interfaces for sharing digital media.

FIG. 16 is a diagram illustrating an embodiment of a user interface for sharing digital media.

FIG. 17 is a diagram illustrating an embodiment of a user interface for sharing digital media.

FIG. 18 is a diagram illustrating an embodiment of a user interface for the notification of shared media.

FIG. 19 is a diagram illustrating an embodiment of a user interface for the notification of shared media.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Digital media (e.g., photo, video, etc.) browsing and feedback is disclosed. For example, using artificial intelligence/machine learning, digital media may be automatically shared with approved contacts. The approved contacts view the collection of shared media through a user interface that provides for context aware digital media browsing and automatic feedback of digital media interaction. When a user input is received, a magnitude value is determined based on the user input gesture and properties that are associated with each individual shared digital media. The magnitude value is used to advance through the collection of shared digital media (e.g., by scrolling). When browsing the collection, feedback based on passive and active input from the user and/or other approved contacts is provided to the user via the shared digital media properties. The feedback may be used to increase or decrease how quickly a user can advance through the shared media collection. The feedback may also be used to identify interests and characteristics associated with the shared media and provide the user an opportunity to actively respond to the media (e.g., leave a comment, annotate, share, etc.).

In some embodiments, a user has a collection of digital media, such as photos and/or videos, to be displayed sequentially. For example, the collection may be a collection of photos that are shared with the user by his or her friends and family. One or more initial digital media from the collection are displayed on a device, such as a smartphone, virtual reality headset, smart television, etc. To browse subsequent media of the collection, the user performs an input gesture on the device. For example, an input gesture may be a swipe on a touchscreen device or a wave gesture in response to the display on a virtual reality headset. Using a processor of the device, a magnitude value is associated with the input gesture. In some embodiments, the magnitude value is based on a speed and acceleration associated with the gesture. For example, the speed may increase if the speed of the gesture increases based on the acceleration of the gesture. As another example, the speed may also increase if multiple gestures are performed in quick succession. In some embodiments, the magnitude value is based on the distance associated with the gesture. In response to the gesture(s), additional digital media is displayed based on the magnitude value. For example, the user interface advances to subsequent digital media by an amount corresponding to the magnitude value. As another example, the user interface scrolls through the collection of digital media by an amount corresponding to the magnitude value. The input gesture may be provided to advance the displayed media forwards or backwards in sequence of a plurality of media (e.g., advance in either direction). In some embodiments, the sequential media is ordered in more than one dimension, and the input gesture may be used to advance the displayed media along multiple dimensions, for example, down and towards the left, for shared media ordered in two-dimensions.

In some embodiments, the determination of the magnitude value is based on properties that are associated with each individual shared digital media. The amount of the magnitude value corresponding to each individual digital media may be different. In some embodiments, the amount contributed by one digital media may be larger than the amount contributed by a second digital media. In some embodiments, the amount is context aware and based on properties of the current digital media. For example, the amount of effort or distance required to advance from the current digital media to the next digital media may be different based on the properties of the current digital media. As another example, in the event an input gesture is a swipe, for one digital media, the distance associated with the swipe may require a longer distance to advance to the next media than for another digital media. As another example, the distance associated with the swipe may require a longer distance for a photo identified as popular compared to the distance required for an average photo.

In some embodiments, as the user is browsing a collection of digital media, the device automatically detects interaction with the digital media and provides feedback based on the interaction. In some embodiments, automatic detection captures user interaction when the current media has been displayed for at least a threshold amount of time. In the event the displayed media has been displayed for at least a threshold amount of time, an indication is provided. For example, in the event a user views a particular media for more than three seconds, a gaze indication is provided. In some embodiments, the gaze indication results in additional user interface events, such as a visual indicator (e.g., a pop-up, an overlay, a floating icon, an emoji, a highlight, etc.) that a gaze indication has been provided. In some embodiments, the indication may be a focus indication that corresponds to viewing or interacting with a particular area of the media for at least a threshold amount of time. For example, in the event an eye tracker identifies that the user views a particular location of the media for more than three seconds, a focus indication is provided. As another example, in the event a video is paused or looped over a particular portion of the video, a frame focus indication is triggered.

In some embodiments, once an indication is provided, a notification is sent corresponding to the indication. For example, a network notification to a media sharing service is sent to store information of the indication. As an example, when a gaze notification is presented, a notification over the network to a media sharing server is sent that contains information corresponding to the interaction that triggered the indication. In some embodiments, the notification is utilized to provide a second user with information associated with an interaction with the digital media. As an example, a second user may be the user who originally shared the media or any other user viewing the same media. The user may be presented with a visual indicator associated with the indication such as a pop-up, an overlay, a floating icon, an emoji, a highlight, or other similar visual indicator associated with the media. In some embodiments, the notification is used to inform the original sharer of the media that an indication associated with the shared media has been triggered. For example, a user is informed in the event that a gaze indication was triggered by another user viewing his or her shared photo for at least a threshold amount of time. Based on the notification, a user may be informed of access and interaction with shared media that he or she would have otherwise been unaware of In some embodiments, the notification may be used to address computer security deficiencies. For example, in the event a media that is not desired to be shared is inadvertently shared, the notification informs the user of access by other users to the media. As another example, the notification informs the user of interactions and the type of activity associated with the media.

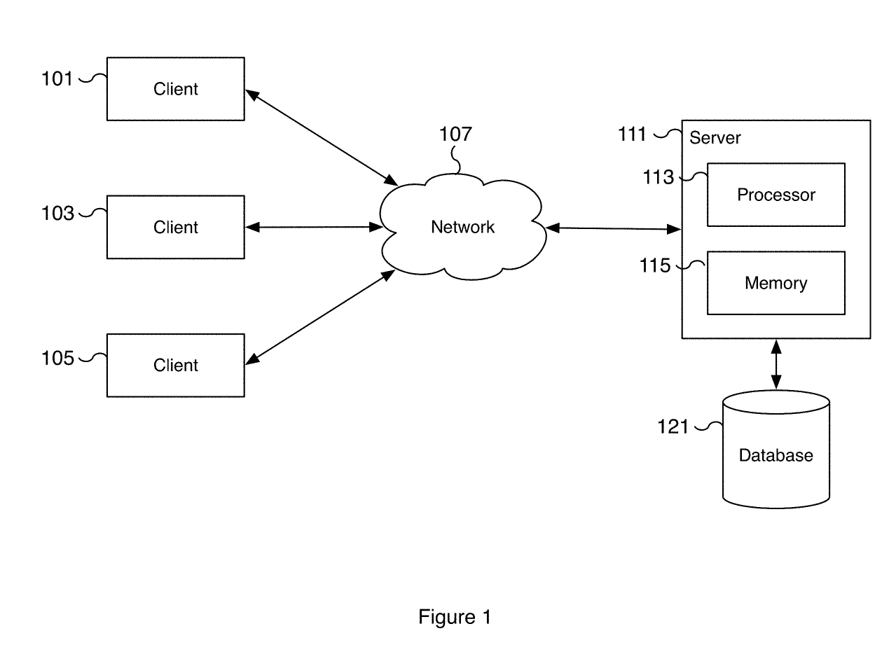

FIG. 1 is a block diagram illustrating an example of a communication environment between a client and a server for sharing and/or accessing digital media. In the example shown, clients 101, 103, and 105 are network computing devices with media for sharing and server 111 is a digital media sharing server. Examples of network computer devices include but are not limited to a smartphone device, a tablet, a laptop, a virtual reality headset, an augmented reality device, a network connected camera, a gaming console, and a desktop computer. Clients 101, 103, and 105 are connected to server 111 via network 107. Examples of network 107 include one or more of the following: a mobile communication network, the Internet, a direct or indirect physical communication connection, a Wide Area Network, a Storage Area Network, and any other form of connecting two or more systems, components, or storage devices together.

Users of clients 101, 103, and 105 generate digital media such as photos, videos, interactive scenes in virtual worlds, etc. For example, client 101 may be a smartphone device that a user creates photos and videos with by using the smartphone's camera. As photos and videos are taken with client 101, the digital media is saved on the storage of client 101. The user of client 101 desires to share only a selection of the digital media on the device without any interaction by the user of client 101. Some photos and videos may be private and the user does not desire to share them. As an example, the user may not desire to automatically share photos of documents, which may include photos of financial statements, personal records, credit cards, and health records. As another example, the user may not desire to automatically share photos that contain nudity. In another example, the user may not desire to automatically share screenshot images/photos.

In the example shown, users of clients 101, 103, and 105 selectively share their digital media with others automatically based on sharing desirability. The media generated by clients 101, 103, and 105 is automatically detected and analyzed using a machine learning model to classify the detected media into categories. Based on the identified category, media is marked for sharing and automatically uploaded through network 107 to server 111 for sharing. In some embodiments, the classification is performed on the client such as on clients 101, 103, and 105. For example, a background process detects new media, such as photos and videos, as they are created on a client, such as client 101. Once detected, a background process automatically analyzes and classifies the media. A background process then uploads the media marked as desirable for sharing to a media sharing service running on a server such as server 111. In some embodiments, the detection, analysis and marking, and uploading process may be performed as part of the media capture processing pipeline. For example, a network connected camera may perform the detection, analysis and marking, and uploading process during media capture as part of the processing pipeline. In some embodiments, the detection, analysis and marking, and uploading process may be performed by an embedded system. In some embodiments, the detection, analysis and marking, and uploading process may be performed in a foreground application. In various embodiments, server 111 shares the shared media with approved contacts. For example, server 111 hosts the shared media and makes it available for approved clients to interact with the shared media. Examples of interaction may include but are not limited to viewing the media, zooming in on the media, leaving comments related to the media, downloading the media, modifying the media, and other similar interactions. In some embodiments, the shared media is accessible via an application that runs on a client, such as on clients 101, 103, and 105, that retrieves the shared media from server 111. Server 111 uses processor 113 and memory 115 to process, store, and host the shared media. In some embodiments, the shared media and associated properties of the shared media are stored and hosted from database 121.

In some embodiments, client 101 contains an approved list of contacts for viewing shared media that includes client 103 but does not include client 105. For example, photos automatically identified by client 101 for sharing are automatically uploaded via network 107 to server 111 for automatic sharing. Once shared, the shared photos are accessible by the originator of the photos and any contacts on the approved list of contacts. In the example, client 101 and client 103 may view the shared media of client 101. Client 105 may not access the shared media since client 105 is not on the approved list of contacts. Any media on client 101 classified as not desirable for sharing is not uploaded to server 111 and remains only accessible by client 101 from client 101 and is not accessible by clients 103 and 105. The approved list of contacts may be maintained on a per user basis such that the list of approved sharing contacts of client 101 is configured based on the input of the user of client 101. In some embodiments, the approved list of contacts may be determined based on device, account, username, email address, phone number, device owner, corporate identity, or other similar parameters. In some embodiments, the shared media may be added to a profile designated by a media publisher. In some embodiments, the profile is shared and/or made public.

In some embodiments, the media on clients 101, 103, and 105 is automatically detected and uploaded via network 107 to server 111. Once the media is uploaded to server 111, server 111 automatically analyzes the uploaded media using a machine learning model to classify the detected media into one or more categories. Based on an identified category, media is marked for sharing and automatically made available for sharing on server 111. For example, client 101 detects all generated media and uploads the media via network 107 to server 111. Server 111 performs an analysis on the uploaded media and, using a machine learning model, classifies the detected media into media approved for sharing and media not for sharing. Server 111 makes the media approved for sharing automatically available to approved contacts configured by client 101 without any interaction required by client 101.

In some embodiments, the collection of digital media on clients 101, 103, and 105 is viewed using a user interface for accelerated media browsing. In some embodiments, context aware browsing includes receiving input gestures on the devices of clients 101, 103, and 105. Properties associated with the media used for context aware browsing and automatic feedback of digital media interaction may be stored in database 121 and sent along with the media to consumers of the media such as clients 101, 103, and 105. In some embodiments, when a digital media viewed on clients 101, 103, and/or 105 is displayed for at least a threshold amount of time, an indication is provided to the user of the corresponding device. For example, the user of clients 101, 103, and/or 105 may receive a gaze indication and a corresponding visual indicator of the gaze indication. An example of a visual indicator may be a digital sticker displayed on the viewed media. Other examples include a pop-up, various overlays, a floating icon, an emoji, a highlight, etc. In some embodiments, a notification associated with the indication is sent over network 107 to server 111. In some embodiments, the notification includes information associated with an interaction with the shared media. For example, the information may include the particular media that was viewed, the length of time it was viewed, the user who viewed the media, the time of day and location the media was viewed, feedback (e.g., comments, share status, annotations, etc.) from the viewer on the media, and other additional information. In some embodiments, server 111 receives the notification and stores the notification and/or information related to the notification in database 121.

In various embodiments, the components shown in FIG. 1 may exist in various combinations of hardware machines. Although single instances of components have been shown to simplify the diagram, additional instances of any of the components shown in FIG. 1 may exist. For example, server 111 may include one or more servers for hosting shared media and/or performing analysis of detected media. Components not shown in FIG. 1 may also exist.

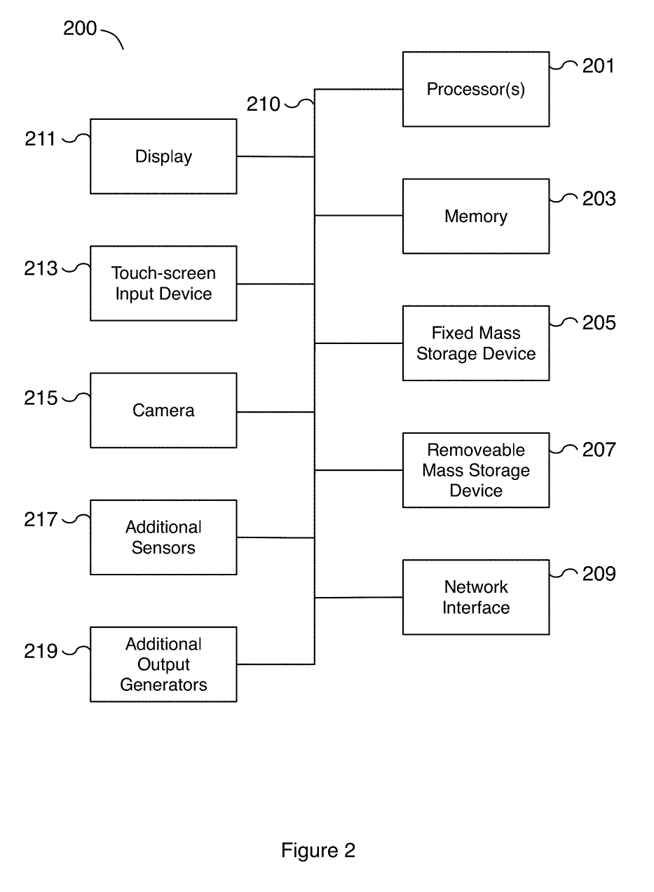

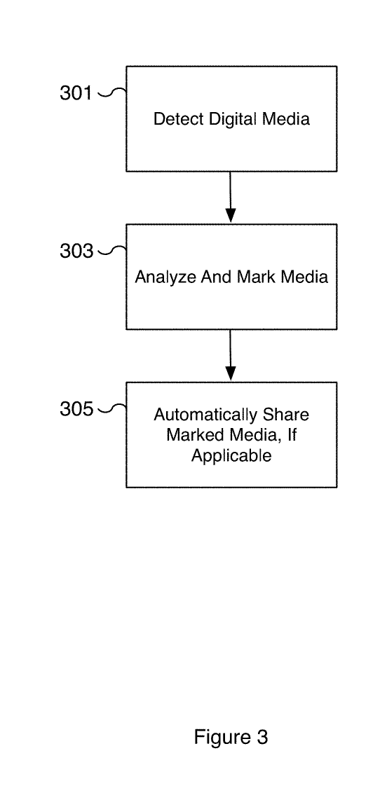

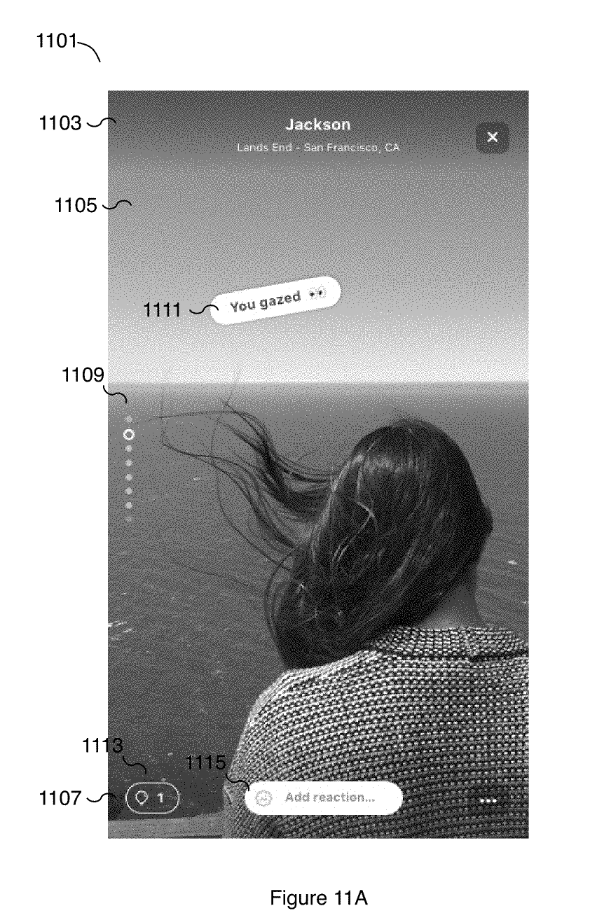

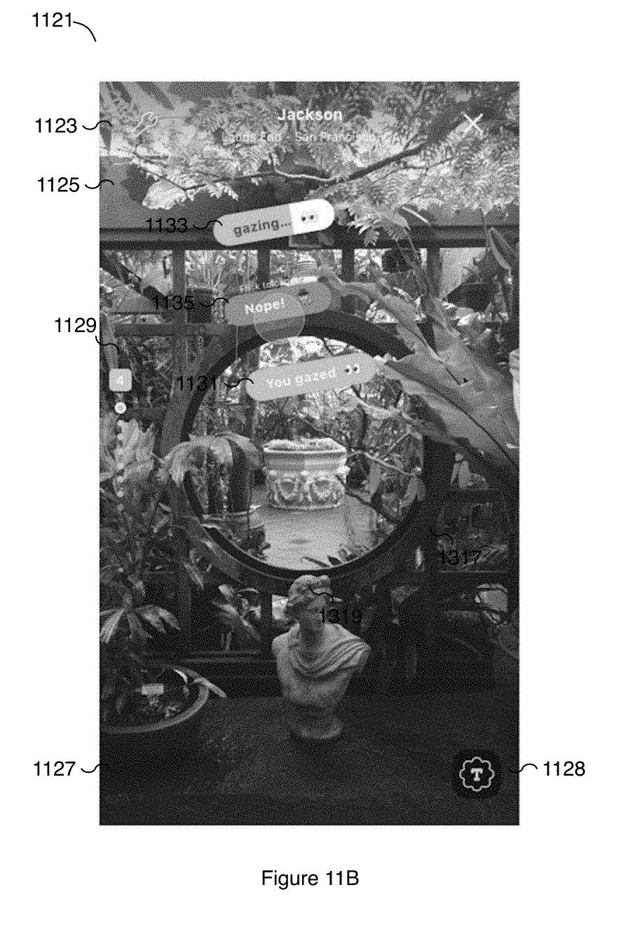

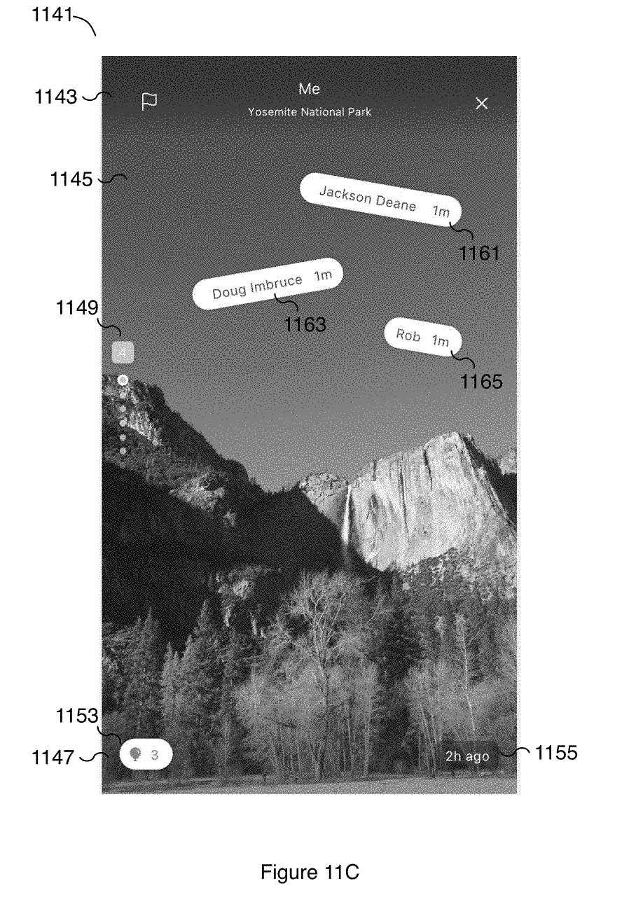

FIG. 2 is a functional diagram illustrating a programmed computer system for sharing and/or accessing digital media in accordance with some embodiments. As will be apparent, other computer system architectures and configurations can be used to perform automatic sharing of desired digital media. Computer system 200, which includes various subsystems as described below, includes at least one microprocessor subsystem (also referred to as a processor or a central processing unit (CPU)) 201. For example, processor 201 can be implemented by a single-chip processor or by multiple processors. In some embodiments, processor 201 is a general purpose digital processor that controls the operation of the computer system 200. In some embodiments, processor 201 may support specialized instruction sets for performing inference using machine learning models. Using instructions retrieved from memory 203, the processor 201 controls the reception and manipulation of input data, and the output and display of data on output devices (e.g., display 211). In some embodiments, processor 201 includes and/or is used to provide functionality for sharing desired digital media including detecting new digital media, analyzing and marking media for sharing desirability, and uploading desirable for sharing media. In some embodiments, processor 201 includes and/or is used to provide functionality for context aware media browsing and automatic feedback of digital media interaction including determining a magnitude value associated with an input gesture and the amount a magnitude value corresponds to scrolling based on properties of a digital media. In some embodiments, processor 201 includes and/or is used to provide functionality for receiving digital media and for providing an indication and sending a notification in the event the media has been displayed for at least a threshold amount of time. In some embodiments, processor 201 includes and/or is used to provide elements 101, 103, 105, and 111 with respect to FIG. 1 and/or performs the processes described below with respect to FIGS. 3-10. In some embodiments, processor 201 runs the graphical user interfaces depicted in FIGS. 11-19.

Processor 201 is coupled bi-directionally with memory 203, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 201. Also as is well known in the art, primary storage typically includes basic operating instructions, program code, data, and objects used by the processor 201 to perform its functions (e.g., programmed instructions). For example, memory 203 can include any suitable computer-readable storage media, described below, depending on whether, for example, data access needs to be bi-directional or uni-directional. For example, processor 201 can also directly and very rapidly retrieve and store frequently needed data in a cache memory (not shown).

A removable mass storage device 207 provides additional data storage capacity for the computer system 200, and is coupled either bi-directionally (read/write) or uni-directionally (read only) to processor 201. For example, storage 207 can also include computer-readable media such as flash memory, portable mass storage devices, magnetic tape, PC-CARDS, holographic storage devices, and other storage devices. A fixed mass storage 205 can also, for example, provide additional data storage capacity. Common examples of mass storage 205 include flash memory, a hard disk drive, and an SSD drive. Mass storages 205, 207 generally store additional programming instructions, data, and the like that typically are not in active use by the processor 201. Mass storages 205, 207 may also be used to store digital media captured by computer system 200. It will be appreciated that the information retained within mass storages 205 and 207 can be incorporated, if needed, in standard fashion as part of memory 203 (e.g., RAM) as virtual memory.

In addition to providing processor 201 access to storage subsystems, bus 210 can also be used to provide access to other subsystems and devices. As shown, these can include a display 211, a network interface 209, a touch-screen input device 213, a camera 215, additional sensors 217, additional output generators 219, and as well as an auxiliary input/output device interface, a sound card, speakers, a keyboard, additional pointing devices, and other subsystems as needed. For example, the additional sensors 217 may include a location sensor, an accelerometer, a heart rate monitor, and/or a proximity sensor, and may be useful for interacting with a graphical user interface and/or capturing additional context to associate with digital media. As other examples, the additional output generators 219 may include tactile feedback motors, a virtual reality headset, and augmented reality output.

The network interface 209 allows processor 201 to be coupled to another computer, computer network, or telecommunications network using one or more network connections as shown. For example, through the network interface 209, the processor 201 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 201 can be used to connect the computer system 200 to an external network and transfer data according to standard protocols. For example, various process embodiments disclosed herein can be executed on processor 201, or can be performed across a network such as the Internet, intranet networks, or local area networks, in conjunction with a remote processor that shares a portion of the processing. Additional mass storage devices (not shown) can also be connected to processor 201 through network interface 209.

An auxiliary I/O device interface (not shown) can be used in conjunction with computer system 200. The auxiliary I/O device interface can include general and customized interfaces that allow the processor 201 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above and magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 2 is but an example of a computer system suitable for use with the various embodiments disclosed herein. Other computer systems suitable for such use can include additional or fewer subsystems. In addition, bus 210 is illustrative of any interconnection scheme serving to link the subsystems. Other computer architectures having different configurations of subsystems can also be utilized.

FIG. 3 is a flow diagram illustrating an embodiment of a process for automatically sharing desired digital media. In some embodiments, the process of FIG. 3 is implemented on clients 101, 103, and 105 of FIG. 1. In some embodiments, the process of FIG. 3 is implemented on server 111 of FIG. 1. In some embodiments, the process of FIG. 3 occurs without active participation or interaction from a user.

In the example shown, at 301, digital media is automatically detected. For example, recently created digital media, such as photos or videos newly taken, is detected for processing. As another example, digital media that has not previously been analyzed at 303 (as discussed below) is detected. In some embodiments, the detected media is stored on the device. In some embodiments, the detected media is live media, such as a live video capture. In some embodiments, the live media is media being streamed. As an example, a live video may be a video conference feed. In some embodiments, the live video is streamed and not stored in its entirety. In some embodiments, the live video is divided into smaller chunks of video which are saved on the device for analysis.

At 303, the detected digital media is automatically analyzed and marked. The analysis of digital media is performed using machine learning and artificial intelligence. In some embodiments, the analysis using machine learning and artificial intelligence classifies the detected media into categories. For example, a machine learning model is trained using a corpus of photos from multiple categories. The training results in a machine learning model with trained weights. Inference is run on each detected media to classify it into one or more categories using the trained multi-classifier. Categories may include one or more of the following: approved, documents, screenshots, unflattering, blurred, gruesome, medically-oriented, and private, among others. In some embodiments, private media is media that may contain nudity. In some embodiments, the analysis classifies the media into a single category. In some embodiments, the analysis classifies the media into more than one categories. In some embodiments, the output of a multi-classifier is a probability distribution across all categories. In some embodiments, different thresholds may exist for identifying whether a media belongs to a particular category. For example, in the event that the analysis is tuned to be more sensitive to nudity, a threshold for classification for nudity may be lower than the threshold for documents. In some embodiments, the output of classification is further analyzed, for example, by using one or more additional stages of machine learning and artificial intelligence. In some embodiments, one or more additional stages of machine learning and artificial intelligence are applied prior to classification. For example, image recognition may be applied using a machine learning model prior to classification. In various embodiments, the identified categories determine if the analyzed media is desirable for sharing. As an example, the categories documents and private may not be desired for sharing. In some embodiments, the remaining categories that are not marked not desired for sharing are approved for sharing. The analyzed media is automatically marked for sharing or not for sharing based on classification. In some embodiments, all digital media captured and/or in specified folder(s) or album(s) is to be automatically shared unless specifically identified/classified as not desirable to share.

At 305, the analyzed digital media is automatically shared, if applicable. For example, in the event the media is not marked for not desirable for sharing, it is automatically shared. For example, in the event the media is marked as not desirable for sharing, it is not uploaded for sharing with specified/approved contact(s) and other media (e.g., all media captured by user device or all media in specified folder(s) or album(s)) not marked as not desired for sharing) is automatically shared. In some embodiments, despite a digital media being not identified/marked as not desirable to share, a user may manually identify/mark the media as not desirable to share and this media is not automatically shared. In some embodiments, a media that has been automatically shared may be removed from sharing. For example, the user that automatically shared the media may apply an indication to no longer share the media. In another example, in the event the media is marked desirable to share, it is automatically shared. For example, only media specifically identified/marked using machine learning as desirable for sharing is automatically shared. In some embodiments, despite a digital media being identified/marked as not desirable to share, a user may manually identify/mark the media as desirable to share and this media is automatically shared.

In some embodiments, if the media is marked for sharing, it is automatically uploaded to a media sharing server such as server 111 of FIG. 1 over a network such as network 107 of FIG. 1. In some embodiments, the uploading of media for sharing is performed as a background process without user interaction. In various embodiments, the uploading is performed in a process that is part of a foreground application and that does not require user interaction. In various embodiments, the media is shared with approved contacts. For example, an approved contact may receive a notification that newly shared media from a friend is available for viewing. The approved contact may view the shared media in a media viewing application. In another example, the newly shared media will appear on the devices of approved contacts at certain refresh intervals or events. In some embodiments, prior to automatically sharing the media, the user is provided a message or indication that the media is going to be automatically shared (e.g., after a user configurable time delay) and unless otherwise instructed by the user, the media is automatically shared. For example, a user is provided a notification that twelve recently taken photos are going to be automatically shared after a time delay period of ten minutes. Within this time delay period, the user has the opportunity to preview the photos to be automatically shared and instruct otherwise to not share indicated one(s) of the photos.

In some embodiments, the media marked for sharing is shared after a configurable time delay. In some embodiments, the user may bypass the time delay for sharing media marked for sharing. For example, the user may express the user's desire to immediately share media marked for sharing. In some embodiments, the user bypasses a time delay for sharing media marked for sharing by performing a shaking gesture. For example, a user may shake a device, such as a smartphone, to indicate the user's desire to bypass the time delay for sharing media marked for sharing. In some embodiments, a sensor in the device, such as an accelerometer, is used to detect the shaking gesture and triggers the sharing. As other examples, a user may bypasses a time delay for sharing media marked for sharing by interacting with a user interface element, such as a button, control center, sharing widget, or other similar user interface element. In some embodiments, the media marked for sharing is first released and then shared. In some embodiments, once a media is released it is shared immediately. In some embodiments, the media marked for sharing is first released and then shared at a next available time made for processing sharing media.

In some embodiments, a user interface is provided to display to the user media marked for sharing and media marked not for sharing. In some embodiments, the user interface displays a share status for media marked for sharing. For example, the share status may indicate that the media is currently shared, the media is private and not shared, the media is pending sharing, and/or a time associated with when media marked for sharing will be released and shared. In some embodiments, a media pending sharing is a media that is in the process of being uploaded and shared. In some embodiments, a media pending sharing is a media that has been released for sharing but has not been shared. For example, a media may be released for sharing but not shared in the event that the device is unable to connect to a media sharing service (e.g., the device is in an airplane mode with network connectivity disabled). In some embodiments, a media marked for sharing but not released has a countdown associated with the release time. In some embodiments, prior to sharing and/or after a media has been shared, a media may be made private and will not or will no longer be shared.

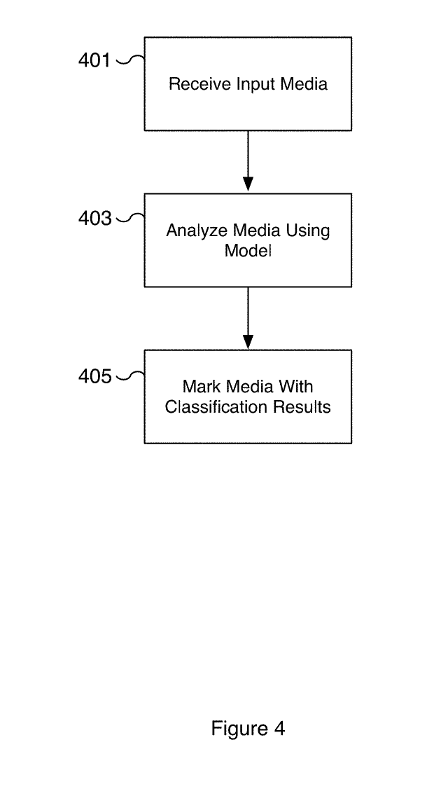

FIG. 4 is a flow diagram illustrating an embodiment of a process for classifying digital media. In some embodiments, the process of FIG. 4 is implemented on clients 101, 103, and 105 of FIG. 1. In some embodiments, the process of FIG. 4 is implemented on server 111 of FIG. 1. In some embodiments, the process of FIG. 4 is performed at 303 of FIG. 3.

In the example shown, at 401, digital media is received as input for classification. For example, a computer process detects the creation of new digital media and passes the new digital media to be received at 401 for classification. In some embodiments, once received, the digital media may be validated. For example, the media may be validated to ensure that it is in the appropriate format, size, color depth, orientation, and sharpness, among other things. In some embodiments, no validation is necessary at 401. In some embodiments, at 401, as part of receiving the digital media, data augmentation is performed on the media. In some embodiments, data augmentation may include applying one or more image processing filters such as translation, rotation, scaling, and skewing. For instance, the media may be augmented using scaling and rotation to create a set of augmented media for analysis. The analysis of each augmented version of media may result in a different classification score. In some scenarios, multiple classification scores are used for classifying a media. In some embodiments, data augmentation includes batching media to improve the computation speed. In some embodiments, validation may take place at 301 of FIG. 3 in the process of detecting digital media.

At 403, a digital media is analyzed and classified into categories. In some embodiments, the result of classification is a probability that the media belongs to one or more categories. In some embodiments, the result of classification is a vector of probabilities. In some embodiments, the classification uses one or more machine learning classification models to calculate one or more values indicating a classification for the media. For example, an input photo is analyzed using a multi-classifier to categorize the photo into one or more categories. Categories may include categories for media that are not desirable for sharing. As an example, a document category and a private category may be categories not desirable for sharing. The document category corresponds to photos identified as photos of documents, which may contain in them sensitive or confidential information. The private category corresponds to photos that may contain nudity. In some embodiments, photos that are not classified into categories not desired for sharing are classified as approved for sharing.

In some embodiments, prior to 403, a corpus of media is curated with multiple categories. In some embodiments, the corpus is human curated. In some embodiments, the categories include approved, documents, and private, where the approved category represents desirable for sharing media. A machine learning model is trained on the corpus to classify media into the identified categories. In some embodiments, the categories are revised over time. In some embodiments, the machine learning model is a deep neural net multi-classifier. In some embodiments, the deep neural net multi-classifier is a convolutional neural network. In some embodiments, the convolutional neural network includes one or more convolution layers and one or more pooling layers followed by a classification, such as a linear classifier, layer.

At 405, the media is marked based on the classification results. Based on the classified categories, the media is automatically identified as not desirable for sharing or desirable for sharing and marked accordingly. For example, if the media is classified to a non-desirable to share category, the media is marked as not desirable for sharing. In some embodiments, the remaining media may be classified as approved for sharing and marked for sharing. In some embodiments, the media is classified into an approved category and is marked for sharing.

In some embodiments, a video is classified by first selecting individual frames from the video. Determining the frames of the video may be performed at 401. The frames are processed into images compatible with the machine learning model of 403 and classified at 403. The output of the classified frames at 403 is used to categorize the video. In 405, the video media is marked as desirable for sharing or not desirable for sharing based on the classification of the frames selected from the video. In some embodiments, if any frame of the video is classified into a category not desirable for sharing then the video is marked as not desirable for sharing. In some embodiments, the frames selected are memorable frames of the video. In some embodiments, memorable frames are based on identifying memorable events or actions in the video. In some embodiments, memorable frames may be based on the number of individuals in the frame, the individuals identified in the frame, the location of the frame, audio analyzed from the frame, and/or similarity of the frame to other media such as shared photos. In some embodiments, memorable frames may be based on analyzing the audio of a video. For example, audio analysis may be used to recognize certain individuals speaking; a particular pattern of audio such as clapping, singing, laughing, etc.; the start of dialogue; the duration of dialogue; the completion of dialogue; or other similar audio characteristics. In some embodiments, the frames selected are based on the time interval the frames occur in the video. For example, a frame may be selected at every fixed interval. As an example, in the event the set fixed time interval is five seconds, a frame is extracted from the video every five seconds and analyzed for classification. In some embodiments, the frames selected are key frames. In some embodiments, the frames selected are based on the beginning or end of a transition identified in the video. In some embodiments, the frames selected are based on the encoding used by the video. In some embodiments, the frames selected include the first frame of the video.

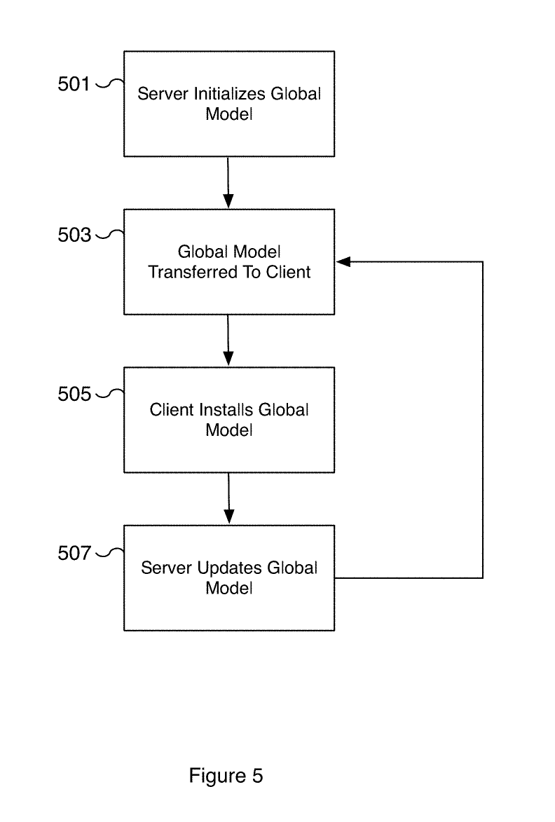

FIG. 5 is a flow diagram illustrating an embodiment of a process for the creation and distribution of a machine learning model. In some embodiments, the process of FIG. 5 is implemented on clients 101, 103, and 105 and server 111 of FIG. 1. In some embodiments, the client described in FIG. 5 may be any one of clients 101, 103, and 105 of FIG. 1 and the server described in FIG. 5 is server 111 of FIG. 1. In some embodiments, the client and the server are separate processes that execute on the same physical server machine or cluster of servers. For example, the client and server may be processes that run as part of a cloud service. In some embodiments, the process of 503 may be performed as part of or prior to 301 and/or 303 of FIG. 3.

In the example shown, at 501, a server initializes a global machine learning model. In some embodiments, the initialization includes the creation of a corpus and the model weights determined by training the model on the corpus. In some embodiments, the data of the corpus is first automatically augmented prior to training. For example, in some embodiments, image processing techniques are applied on the corpus that provide for a more accurate model and improve the inference results. In some embodiments, image processing techniques may include rotating, scaling, and skewing the data of the corpus. In some embodiments, motion blur is removed from the images in the corpus prior to training the model. In some embodiments, one or more different forms of motion blur are added to the corpus data prior to training the model. The result of training with the corpus is a global model that may be shared with multiple clients who may each have his or her unique set of digital media.

At 503, the global model including the trained weights for the model is transferred to a client. For example, a client smartphone device with a camera for capturing photos and video installs a media sharing application. As part of the application, the application installs a global model and corresponding trained weights. In some embodiments, the model and appropriate weights are transferred to the client with the application installation. In various embodiments, once the application is installed, the application fetches the model and appropriate weights for download. In some embodiments, weights are transferred to the client when new weights are available, for example, when the global model has undergone additional training and new weights are determined. In some embodiments, once the model architecture is determined and model weights are trained, the model and weights are converted to a serialized format and transferred to the client. For example, the model and weights may be converted to serialized structured data for download using a protocol buffer.

At 505, the client installs the global model received at 503. For example, a serialized representation of the model and weights is transferred at 503 and unpacked and installed at 505. In some embodiments, a version of the global model is used by the client for inference to determine media desired for sharing. In some embodiments, the output of inference on detected media, additional context of the media, and/or user preferences based on the sharing desirability of media are used to refine the model and model weights. For example, in some embodiments, a user may mark media hidden to reflect the media as not desirable for sharing. The hidden media may be used to modify the model. In some embodiments, the additional refinements made by clients are shared with a server. In some embodiments, only information from media desired for sharing is shared with the server. In this manner, any non-sharable data remains on the client. In some embodiments, contextual information of detected media, as described in additional detail below, is shared with the server. In some embodiments, a server receives additional information to improve the model and weights. In some embodiments, an encoded version of media not desirable for sharing is used to improve the model. In some embodiments, the encoding is a one-way function such that the original media can not be retrieved from the encoded version. In this manner, media not desirable for sharing may be used to improve the model without sharing the original media.

At 507, the server updates the global model. In some embodiments, the corpus is reviewed and new weights are determined. In some embodiments, the model architecture is revised, for example, by the addition or removal of convolution or pooling layers, or similar changes. In some embodiments, the additional data received by clients is fed back into the model to improve inference results. In some embodiments, decentralized learning is performed at the client and partial results are synchronized with the server to update the global model. For example, one or more clients may adapt the global model locally. The adapted global models are sent to the server by clients for synchronization. The server synchronizes the global model using the client adapted models to create an updated global model and weights. The result of 507 may be an updated model and/or updated model weights.

In the event the global model is updated at 507, at 503, the updated global model is transferred to the client. In various embodiments, the model and/or appropriate weights are refreshed at certain intervals or events, such as when a new model and/or weights exist. As an example, a client is notified by a silent notification that a new global model is available. Based on the notification, the client downloads the new global model in a background process. As another example, a new global model is transferred when a media sharing application is in the foreground and has determined that a model update and/or updated weights exist. In some embodiments, the update occurs automatically without user interaction.

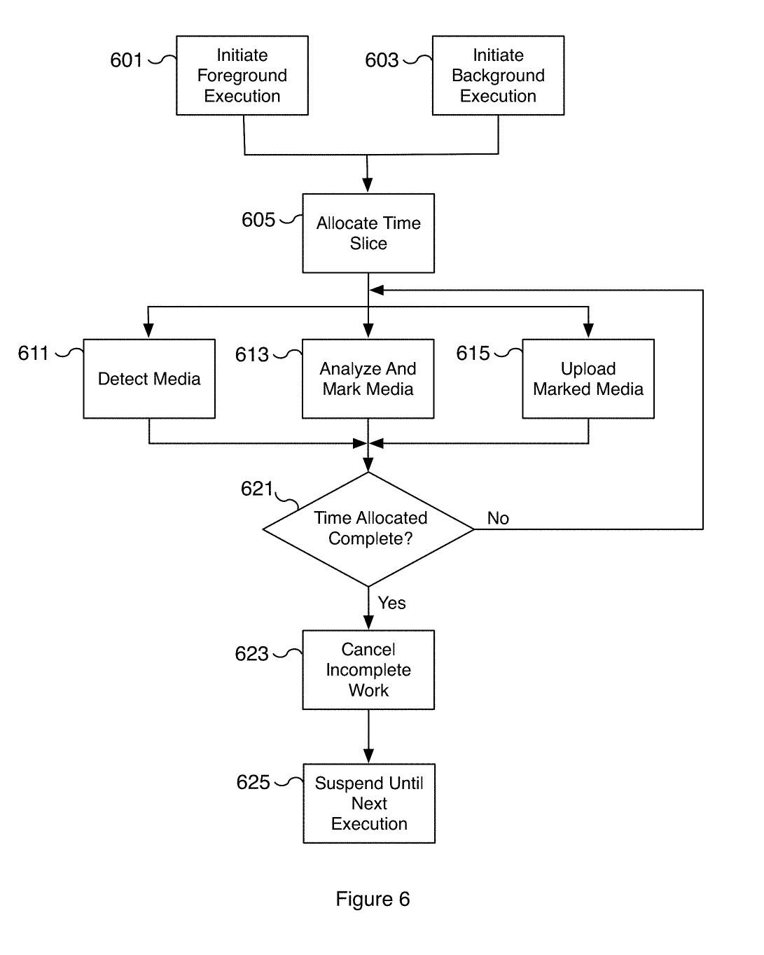

FIG. 6 is a flow diagram illustrating an embodiment of a process for automatically sharing desired digital media. In some embodiments, the process of FIG. 6 is implemented on clients 101, 103, and 105 of FIG. 1. In some embodiments, the process of FIG. 6 is implemented on a server machine, such as server 111 of FIG. 1, or a cluster of servers that run as part of a cloud service. In some embodiments, the process of FIG. 6 is performed by a media sharing application running on a mobile device.

In the example shown, the initiation of automatic sharing of desired digital media can be triggered from either a foreground process at 601 or a background process at 603. At 601, an application running in the foreground initiates the automatic sharing of desired digital media. For example, a user opens a media sharing application that may be used for viewing and interacting with shared digital media. In some embodiments, the foreground process initiates automatic sharing of desired digital media. In various embodiments, the foreground application creates a separate process that initiates automatic sharing of desired digital media.

At 603, background execution for automatic sharing of desired digital media is initiated. In some embodiments, the background execution is initiated via a background process. In various embodiments, background execution is triggered by an event that wakes a suspended application. In some embodiments, events are monitored by the operating system of the device, which wakes a suspended application when system events occur. In some embodiments, background execution is triggered by a change in location event. For example, on some computer systems, an application can register to be notified when the computer system device changes location. For example, in the event a mobile device transitions from one cell tower to another cell tower, a change of location event is triggered. As another example, in the event a device's change in location exceeds a threshold, as determined using a location system such as a global positioning system, a change of location event is triggered. In the event a change in location event occurs, a callback is triggered that executes background execution for automatic sharing of desired digital media. As an example, a change in location event results in waking a suspended background process and granting the background process execution time.

In some embodiments, background execution is triggered when a notification event is received. When a notification arrives at a device, a suspended application is awoken and allowed background execution. When a notification is received, a callback is triggered that executes background execution for automatic sharing of desired digital media. In some embodiments, notifications are sent at intervals to trigger background execution for automatic sharing of desired digital media. In some embodiments, the notifications are silent notifications and initiate background execution without alerting the user. In some embodiments, the sending of notifications is optimized for processing the automatic sharing of desired digital media, for example, by adjusting the frequency and/or timing notifications are sent. In some embodiments, notification frequency is based on a user's expected behavior, history, location, and/or similar context. For example, in the event a user frequently captures new media during Friday evenings, notifications may be sent more frequently during that time period. As another example, in the event a user frequently captures new media when the user's location and/or media location are identified as a restaurant, notifications may be sent more frequently in the event the user's location is determined to be at a restaurant. As another example, in the event a user rarely captures new media during sleeping hours, notifications may be sent very infrequently or disabled during those hours.

In some embodiments, background execution is triggered when a system event occurs. As an example, in the event a device comes into WiFi range, the device may switch from a cellular network to a WiFi network and initiate a change in network connectivity event. In some embodiments, in the event a device connects to a WiFi network, a callback is triggered that executes background execution for automatic sharing of desired digital media. As another example, a system event may include when a device is plugged in for charging and/or connected to a power supply. In some embodiments, the execution in 601 and 603 is performed by threads in a multi-threaded system instead of by a process.

Execution initiated by a foreground process at 601 and execution initiated by a background process at 603 proceed to 605. At 605, execution for automatic sharing of desired digital media is triggered from 601 and/or 603 and a time slice for processing the automatic sharing of desired digital media is allocated. In some embodiments, the time slice is allocated by setting a timer. In some embodiments, the duration of the timer is tuned to balance the processing for the automatic sharing of desired digital media with the operation of the device for running other applications and services. In some embodiments, the duration of the timer is determined based on an operating system threshold and/or monitoring operating system load. For example, the duration is set such that the system load for performing automatic sharing of desired digital media is below a threshold that the operating system determines would require terminating the automatic sharing process. In some embodiments, the process for automatic sharing of desired digital media includes monitoring system resources and adjusting the timer accordingly. In various embodiments, the time slice may be determined based on a queue, a priority queue, process or thread priority, or other similar techniques.

Once a time slice has been allocated in 605, at 611, digital media is detected. For example, new and/or existing digital media on the device is detected and prepared for analysis. In some embodiments, only unmarked digital media is detected and analyzed. For example, once the detected digital media is analyzed, it is marked so that it will not be detected and analyzed on subsequent detections. In some embodiments, a process is run that fetches any new digital media, such as photos and/or videos that were created, taken, captured, or otherwise saved onto the device since the last fetch. In some embodiments, the process of 611 is performed at 301 of FIG. 3.

Once a time slice has been allocated in 605, at 613, detected digital media is analyzed and marked based on the analysis. In some embodiments, the digital media that is analyzed is the media detected at 611. In the example shown, the analysis uses machine learning techniques that apply inference on the new media detected. The inference is performed on the client device and classifies the media into categories. Based on the classification, the media is marked as desirable for sharing or not desirable for sharing. In some embodiments, the process of 613 is performed at 303 of FIG. 3.

Once a time slice has been allocated in 605, at 615, media that has been detected, analyzed, and marked as desirable for sharing is uploaded to a digital media sharing server. In some embodiments, additional metadata of the media desirable for sharing is also uploaded. For example, additional metadata may include information related to the output of inference on the digital media such as classified categories; properties of the media including its size, color depth, length, encoding, among other properties; and context of the media such as the location, camera settings, time of day, among other context pertaining to the media. In some embodiments, the media and any additional metadata are serialized prior to uploading. In some embodiments, the process of 615 is performed at 305 of FIG. 3.

In some embodiments, the processes of 611, 613, and 615 may be run in separate stages in processes (or threads) simultaneously and output from one stage may be shared with another stage via inter-process communication. For example, the newly detected media from 611 may be shared with the process of 613 for analysis via inter-process communication. Similarly, the media marked desirable for sharing from 613 may be shared via inter-process communication with the process of 615 for uploading. In some embodiments, the processing of 611, 613, and 615 is split into chunks for batch processing. In some embodiments, the stages of 611, 613, and 615 are run sequentially in a single process.

At 621, the time slice allocated in 605 is checked for completion. In the event the time slice has completed, execution proceeds to 623. In the event the time slice has not completed, processing at 611, 613, and 615 resumes until the time slice completes and/or the time slice is checked at 621 again. In this manner, the processing at 611, 613, and 615 may be performed in the background while a user interacts with the device to perform other tasks. In some embodiments, in the event the processing at 611, 613, and 615 completes prior to the time slice completing, the processes at 611, 613, and 615 may wait for additional data for processing. The execution of 621 follows from the execution of 611, 613, and 615. In some embodiments, the process of 621 is triggered by the expiration of a timer set in 605.

In the event that the time slice allocated for the processing of automatic sharing of desired digital media has completed in 621, at 623, any incomplete work is cancelled. Incomplete work may include work to be performed by 611, 613, and 615. In some embodiments, the progress of work performed by 611, 613, and 615 is recorded and suspended. In the event additional time is later granted, the work performed by 611, 613, and 615 resumes. In various embodiments, the work may be cancelled and in the event additional execution time is granted, previously completed partial work may need to be repeated. For example, in the event inference is run on a photo that has not completed classification, the photo may require repeating the classification analysis when execution resumes.

Once any incomplete work has been cancelled at 623, at 625, the processing for automatic sharing of desired digital media is suspended until the next execution. For example, once the time allocated for processing completes, the process(es) performing the automatic sharing of desired digital media are suspended and placed in a suspended state. In some embodiments, the processes associated with 611, 613, and 615 are suspended. In some embodiments, the processes associated with 611, 613, and 615 are terminated and control returns to a parent process that initiated them. In some embodiments, a parent process performs the processing of 605, 621, 623, and/or 625. In some embodiments, the resources required for the automatic sharing of desired digital media while in a suspended state are minimal and the majority of the resources are reallocated by the system to other tasks.

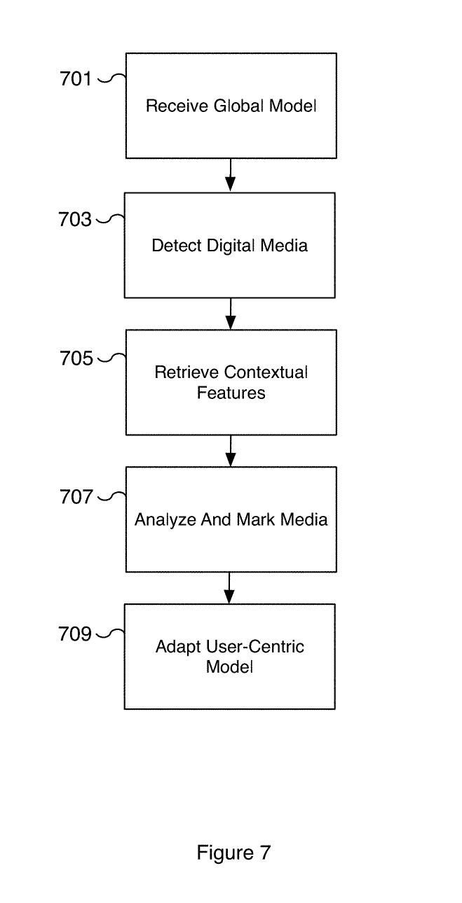

FIG. 7 is a flow diagram illustrating an embodiment of a process for applying a context-based machine learning model. In some embodiments, the process of FIG. 7 is implemented on clients 101, 103, and/or 105 and/or server 111 of FIG. 1. In some embodiments, the client and the server are separate processes but are performed on the same physical server machine or cluster of servers. For example, the client and server may be processes that run as part of a cloud service. In some embodiments, the process of FIG. 7 may be performed as part of or prior to 301 and/or 303 of FIG. 3.

In the example shown, at 701, a client receives a global model. For example, a global machine learning model and trained weights are transferred from a server to a client device. In some embodiments, a CNN model is received for running inference on digital media. At 703, digital media is automatically detected for the automatic sharing of desired digital media. For example, newly created media is detected and queued for analysis. At 705, contextual features are retrieved. The contextual features are features related to the context of the digital media and may include one or more features as described herein. In some embodiments, contextual features may be based on features related to the location of the media, recency of the media, frequency of the media, content of the media, and other similar contextual properties associated with the media. Examples of contextual features related to the recency and frequency of media include but are not limited to: time of day, time since last media was captured, number of media captured in a session, depth of media captured in a session, number of media captured within an interval, how recent the media was captured, and how frequent media is captured. Examples of contextual features related to the location of the media include but are not limited to: location of the media as determined by a global positioning system, distance the location of the media is relative to other significant locations (e.g., points of interest, frequently visited locations, bookmarked locations, etc.), distance traveled since the last location update, whether a location is a public place, whether a location is a private place, status of network connectivity of the device, and WiFi connectivity status of the user. Examples of contextual features related to the content of the media include but are not limited to: number of faces that appear in the media, identify of faces that appear in the media, and identification of objects that appear in the media. In some embodiments, the contextual features are based on the machine learning model applied to the media, such the version of the model applied and/or classification scores.

In some embodiments, the contextual features originate from sensors of the device, such as the global positioning system or location system, real-time clock, orientation sensors, accelerometer, or other sensors. For example, the context may include the time of day, the location, and the orientation of the device when the detected digital media of 703 was captured. In some embodiments, the contextual features include context based on similar media or previously analyzed similar media. For example, the location of a photo may be determined to be a public place or a private place based on other media taken at the same location. As an example, video of a football stadium is determined to be a taken in a public place if other media taken at the stadium is characterized as public. As another example, a photo taken in a doctor's office is determined to be taken in a private place if other media taken at the doctor's office is characterized as private.

In some embodiments, a location is determined to be a public place if one or more users shared media from the location previously. In some embodiments, the location is determined to be a private location if the user has previously desired not to share media of the location. As another example, contextual information includes individuals who have viewed similar media and may be interested in the detected media. Additional examples of contextual information based on similar media or previously analyzed similar media include similarity of the media to recently shared or not shared media.

In some embodiments, the contextual features include context within the digital media detected. For example, contextual features may include the identity of individuals in the digital media, the number of individuals (or faces) in the digital media, the facial expressions of individuals in the digital media, and other similar properties. In some embodiments, the contextual features include context received from a source external to the device. As an example, contextual features may include reviews and/or ratings of the location the media was taken. In the scenario that a photo taken at a restaurant is detected, contextual information of the photo may be retrieved from an external data source and may include a rating of the restaurant, sharing preferences of past patrons of the restaurant, and/or the popularity of the restaurant.

After the contextual features at 705 are retrieved, at 707, the detected media is analyzed and marked as not desirable for sharing or desirable for sharing by classifying the detected media in part based on the context. For example, detected media is classified using a context-based model to determine categories for the media. Based on the categories, the media is marked as desirable for sharing or not desirable for sharing. In some embodiments, the specific actions performed at 707 are described with respect to FIG. 4 but using a context-based model. In some embodiments, a context-based machine learning model is trained on a corpus curated using training data that contains context associated with the media and classified into categories. In some embodiments, the categories have an associated desirability for sharing. In some embodiments, the context is used as input into a machine learning model, such as a multi-classifier, where values based on the context are features of the model. In some embodiments, the weighted outputs of a classification layer, such as the final layer of a Convolutional Neural Network layer or an intermediary layer, are combined with the context as features to a linear model. The linear model, such as a Logistic Regression binary classifier, may combine contextual and deep learned features into an input vector which is used for classification. In some embodiments, the deep learned model and linear model are combined into an ensemble learner which may use a weighted combination of both models. In some embodiments, a Meta Learner may be trained to learn both models in combination. In some embodiments, the trained weights based on the contextual features are used to create a model for classification.

Once the detected media has been analyzed for classification and marked as desirable or not desirable for sharing, at 709, a user-centric model may be adapted. In some embodiments, a user-centric model is a context-based model that is personalized to an individual or group of users. For example, a user-centric model is a context-based model that is created or updated based on feedback from a user or group of users. In some embodiments, the user-centric model is based on the results of analysis from 707. In various embodiments, a user-centric model is based on user feedback and combines content features and contextual features. In some embodiments, the user-centric model created or updated in 709 is used for analysis in 707.

In some embodiments a user-centric model is a machine learning model specific to a particular user. In some embodiments, a user-centric model is individualized for a particular user based on the user's feedback. For example, a personalized user-centric model is based on implicit feedback from the user, such as photos a user chooses not to share. In some embodiments, a user-centric model is a machine learning model specific to a group of users and is adapted from a global model. For example, a global model is adapted based on the feedback of a group of users. In some embodiments, the user group is determined by a clustering method.

In various embodiments, the analysis performed at 707 and the user-centric model adapted in 709 are used to revise a global model. For example, a global model is trained and distributed to clients for use in classification. Based on the results of the global model and contextual features of the detected media, a user-centric model is adapted. In some embodiments, the feedback from the global model and/or the user-centric model is used to revise the global model. Once revised, the global model may be redistributed to clients for analysis and additional revision.

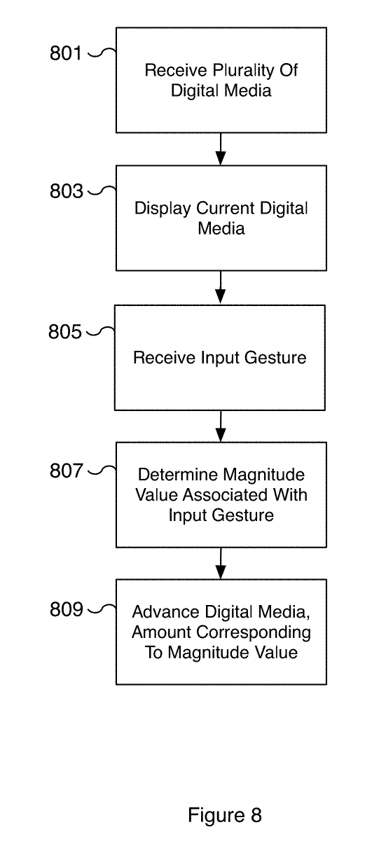

FIG. 8 is a flow diagram illustrating an embodiment of a process for advancing digital media by an amount corresponding to a magnitude value. In some embodiments, the process of FIG. 8 is implemented on clients 101, 103, and/or 105 of FIG. 1. In some embodiments, the process of FIG. 8 is implemented on clients 101, 103, and/or 105 of FIG. 1 using digital media and properties associated with the digital media received from server 111 over network 107 of FIG. 1. In some embodiments, the properties associated with the digital media are stored in database 121 of FIG. 1. In some embodiments, the digital media is the digital media shared at 305 of FIG. 3.

At 801, a plurality of digital media is received. In some embodiments, the plurality of digital media received is a plurality of digital media shared at 305 of FIG. 3. For example, a collection of digital media shared by another user, such as photos and videos, is received by a device. The digital media may include the actual content of the digital media as well as properties associated with the digital media including feedback on the digital media and properties for customizing the user experience when browsing the media. The properties may include information related to context aware browsing of the media such as information related to the amount of effort required to advance past the media when displayed. In some embodiments, the browsing properties are implemented as feedback of the media. The feedback may also include comments on the media, annotations to the media, which users have viewed the media, the location of the media, the time and date the media was captured or created, and the time and date the media was shared, among other properties. As an example, a device of an approved contact for receiving shared media receives a collection of photos and videos shared by the user's spouse. The shared media includes feedback of the media including information for accelerated browsing of the media. The included information for accelerated browsing allows the user to browse through the collection of shared media quickly and helps identify the most relevant media.

At 803, the current digital media is displayed on the device. For example, the current digital media may be the first newly shared media of a collection of newly shared media. In some embodiments, the current digital media is displayed in full screen on the device such as a smartphone. As other examples, the current digital media may be displayed in a virtual reality headset, on a smart television, on augmented reality capable eyewear, on a display monitor, etc. In some embodiments, the current digital media is one of a collection of media for sequential display. For example, the collection of media may be a collection of photos and videos from an event such as a birthday party, a holiday gathering, a vacation, etc. As another example, the collection of media may be newly shared media from a friend or friends. As another example, the collection of media may be newly shared media from an approved contact. In various embodiments, a collection of media may be displayed in various sequential orders such as ordered in chronological order, in reverse chronological order, by the owner of the media, by the sharer of the media, based on expected interests of the viewer, based on user feedback, based on the people, objects, and/or locations identified in the media, etc. In some embodiments, the sequential media is ordered in more than one dimension. For example, the sequential media may be ordered in two dimensions, along an x-axis and a y-axis. As another example, the sequential media may be ordered in three dimensions using an x-axis, y-axis, and z-axis.

In some embodiments, one digital media is displayed at a time and the displayed media corresponds to the current digital media. For example, the display of the current digital media may be displayed to fill up the entire screen. As another example, the current digital media may be scaled to fit to the display area or screen. In some embodiments, navigational and informational information, such as browsing user interface indicators, the owner of the media, and the location of the media, are displayed overlaid on the media. In some embodiments, one media is displayed at a time but only a portion of the media is displayed, such as a zoomed-in view of the current media. For example, for a wide panoramic photo, only a portion of the panoramic photo is displayed. For any given section of the panoramic photo, the entire height of the photo may be displayed but not the entire width. As another example, for a 3D virtual reality scene, only a portion in the field of view is displayed. In some embodiments, more than one digital media is simultaneously displayed. In the event that more than one media is displayed, the current media corresponds to the current media of the sequential media. For example, a current index may be used to identify the current media and index into the collection of sequential media. In some embodiments, the current media is determined by the input gesture. For example, in the event that multiple media are simultaneously displayed, the current media is determined by the media selected by the input gesture.

At 805, an input gesture is received. For example, in the event the device is a touchscreen smartphone device, the received gesture may be one or more swipe gestures. In some embodiments, the gestures are multi-touch gestures, for example, a swipe gesture using multiple fingers. Additional example input gestures include a flick, a wave, eye tracking, and rotation gestures, among others. In various embodiments, the input gesture corresponds to a user input gesture browsing media. In some embodiments, the gesture is used to advance the display of digital media forwards, backwards, or in another direction. In various embodiments, the direction of advancement is based on a direction associated with the gesture input. For example, a gesture in one direction may be used to advance the display of media forwards in the sequential order while a gesture in another direction may be used to advance the display of media backwards in the sequential order. In some embodiments, the advancement advances the media to the next media in accordance to the sequential order. In some embodiments, when media is advanced, the displayed media is no longer displayed and instead replaced with the display of the next media. In some embodiments, the advancement pans the media to display and reveal additional portions of the media.

In some embodiments, based on the input gesture, sequential media is prefetched and/or cached. For example, when an input gesture is received to advance the current displayed media, additional sequential media is loaded. In some embodiments, the number of media to prefetch or cache is based on the size of the media, the magnitude of the input gesture, the network capabilities, and/or other similar factors. In some embodiments, prefetching is part of the caching processes. For example, media is prefetched into cache memory based on priority. In some embodiments, a lower resolution media may be received and displayed until a higher resolution media replaces it. For example, during high-speed scrolling, a low resolution photo may be used in place of a high resolution photo. In the event the user slows down the scrolling and pauses at a particular photo, a high resolution photo is displayed and replaces the low resolution photo. In the event the media is a video, a lower resolution video may be used in place of the higher resolution video. In some embodiments, a lower resolution animation of important frames may be used in place of the actual video.

In some embodiments, the media is prefetched and/or cached based on the anticipated usage behavior of the user. For example, media shared by favorite contacts may be more likely to be viewed and are prefetched with a higher priority than media shared by contacts that are rarely viewed. As another example, in the event a user frequently views media with feedback, then media with feedback is prioritized over media without feedback when prefetching. In some embodiments, media consumption habits are used to prioritize prefetching and/or caching. For example, high consumption media may be prioritized for caching. Examples of factors corresponding to high consumption may include the number of media shared, the total time the media is viewed, the average number of views for a media over a fixed period of time, etc. In some embodiments, the caching is based on the user's social graph. For example, the priority that media is prefetched and/or cached may be based on the relationship of the sharer in the user's social graph. As an example, media from family members may be prioritized above media from co-workers. In some embodiments, the priority that media is prefetched and/or cached may be based on a contact's connections and the user's connections in a social graph. For example, the priority that media is prefetched and/or cached may be based on the number of shared relationships between a user and a contact in a social graph. As an example, shared media from a contact with five common friends is prioritized over shared media from a contact with two common friends. In some embodiments, images are prefetched in a background process when applicable. In various embodiments, prefetching and caching may be performed as part of the processing at 801, 805, and/or 809.

At 807, a magnitude value associated with the input gesture is determined. In some embodiments, the magnitude value is determined based on the user input gesture and properties that are associated with each individual shared digital media. For example, based on the input gesture received at 805 and properties associated with each individual digital media of a collection of media, a magnitude value is determined that corresponds to an amount the user interface advances when displaying the collection of media received at 801. In some embodiments, the magnitude value is based in part on a magnitude value of the input gesture. For example, in some embodiments, the more exaggerated the gesture the larger the magnitude value. In some embodiments, the faster or higher frequency the gesture is performed the larger the magnitude value. In some embodiments, the magnitude value is determined based in part on a default user interface gesture implementation that determines an initial magnitude value or offset associated with the gesture. The initial magnitude value may be used to determine the final magnitude value. For example, in some operating systems, a gesture interface will determine a corresponding value or offset associated with a gesture. In some embodiments, the corresponding value associated with an input gesture is used to determine the magnitude value.

In some embodiments, the magnitude value is also based in part on the context of the digital media. For example, the magnitude value may be based on properties that are associated with each individual digital media. For each digital media, properties associated with the media are used to impact the determined magnitude value. In some embodiments, media properties provide context for browsing digital media and may be used to speed up or slow down the browsing of a collection of media. For certain media, context aware browsing may slow down the browsing when viewing a certain media. In some embodiments, the speed of browsing and/or the effort required to browse each media is based on the context of the media. For example, the speed of browsing may be slowed down by requiring more effort to advance from the current displayed media to the next media. As another example, the speed of browsing may be sped up by requiring less effort to advance from the current displayed media to the next media. In various embodiments, the speed is based on the currently display media.

In some embodiments, context aware browsing may be used to advance media in a context aware manner to highlight key media when viewing a collection of media. For example, when scrolling or navigating through a large collection of media, context aware browsing may slow down the scrolling when an important media is displayed. As another example, context aware browsing may require little effort to advance from one media to the next in order to speed up consumption of the media and quickly browse media that may be less important (e.g., in the event the collection has many similar media). In some embodiments, context aware browsing is used to slow down browsing by increasing the effort required to advance to the next media when the current displayed media has additional feedback, such as comments, annotations, stickers, high popularity, and other similar feedback. In some embodiments, the feedback may be based on the popularity of the media. In some embodiments, the feedback may be based on a determination that the viewer will likely have an interest in the media. For example, a viewer may have a higher interest in media that is similar to past favorites, media from close friends, media that is popular based on subject matter, media identified by machine learning techniques using known favorites, etc.

In some embodiments, the collective properties of the media correspond to how much effort is required to advance from the current media to the next media. In some embodiments, the properties associated with the media are adjusted to customize the media browsing experience for the user. For example, more important media may require additional effort to advance while less important media may require less effort. In some embodiments, based on the properties of the different media, the amount required to advance for one media may be larger than the amount required to advance for a different media. In this manner, using the magnitude value, different media may be emphasized differently while browsing.

At 809, the display of the collection of digital media is advanced to subsequent digital media corresponding to the determined magnitude value. For example, in response to the input gesture and the properties of the currently displayed digital media, the display is advanced to the next digital media in the event the magnitude value exceeds the required threshold. In some embodiments, a single gesture advances through multiple media from the collection of media. For example, a swipe gesture may scroll through multiple photos from a collection of shared photos. However, based on the properties of the photos, certain photos may require more effort, corresponding to a greater proportional impact of the swipe, than other media to scroll through. As another example, given a large collection of photos, the majority of the photos may have a property that requires very little effort to advance past the photo. In contrast, a small subset of the photos may have properties that require a more noticeable effort to advance past. By using custom properties, the browsing experience is tailored to allow the user to quickly browse the media while emphasizing a small subset of a large collection of photos.

In some embodiments, the magnitude value is determined using a feedback vector based on the media properties. A vector may be used in the event a single value is insufficient to describe the media's properties. As an example, a vector may be used to determine tactile feedback in response to an input gesture. In some embodiments, a tactile feedback response includes both a duration and intensity. In some embodiments, a feedback vector may be used to include a value to reflect the effort to advance the media as well as a duration and intensity for tactile feedback when browsing the media. In some embodiments, a feedback vector may also include audio cues for playing when browsing the media and/or visual cues for displaying when browsing the media.

In some embodiments, the properties of a media may be based on the location the input gesture interfaces with the media. For example, for a touchscreen interface, the magnitude value may be based on the location a user touches the displayed media. The properties of the media may include property values associated with certain areas of the media. For example, a highlighted portion of the media may have a higher gradient property than a less important portion of the media. As an example, the foreground or faces of a media may have higher gradients than the background of a media. In some embodiments, a more important area has a lower gradient value than a less important area. In some embodiments, for images, the property value may be associated with a certain area of the image such as the foreground, the background, faces, focal areas, etc. An area of an image may be defined by using a polygon, a circle, or other similar techniques. For videos, the property value may be associated with a certain area as well as duration of the video (e.g., the start and stop time of the highlighted portion). As another example, the property value may be associated with a certain object in the video.

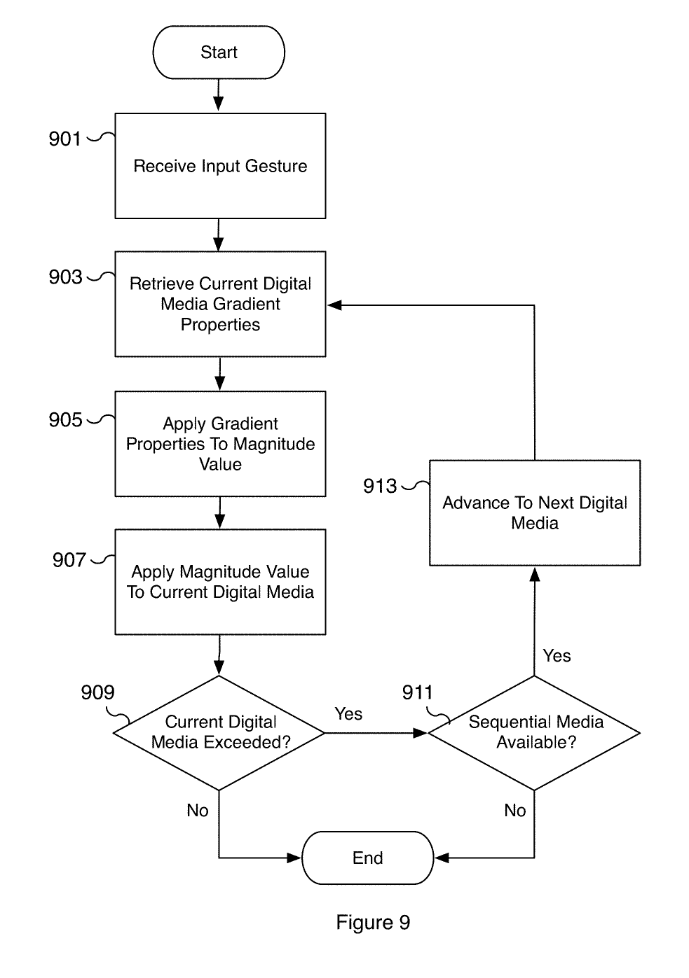

FIG. 9 is a flow diagram illustrating an embodiment of a process for advancing digital media based on gradient properties. In some embodiments, the process of FIG. 9 is implemented on clients 101, 103, and/or 105 of FIG. 1. In some embodiments, the process of FIG. 9 is implemented on clients 101, 103, and/or 105 of FIG. 1 using digital media and properties associated with the digital media received from server 111 over network 107 of FIG. 1. In some embodiments, the properties associated with the digital media are stored in database 121 of FIG. 1. In some embodiments, the digital media is a digital media shared at 305 of FIG. 3. In some embodiments, the process of FIG. 9 is performed at 805, 807, and/or 809 of FIG. 8.

In the example shown, the process begins at 901 where an input gesture is received. In some embodiments, the input gesture is the input gesture received at 805 of FIG. 8. At 903, the current digital media properties are retrieved. In various embodiments, the current media is the media currently displayed to the user. In some embodiments, the current media is a media shared at 305 of FIG. 3. In the example shown, the properties retrieved are gradient properties of the current media. In some embodiments, the gradient property of the media corresponds to how much effort is required to advance from the media to the next media. For example, a media with a high gradient property requires more effort to advance to the next media than a media with a lower gradient property. Similarly, a media with a lower gradient property requires less effort to advance to the next media than a media with a higher gradient property.

In some embodiments, the gradient property is represented in the inverse form, that is, the lower the gradient property of a media the more effort is required to advance to the next media. In some embodiments, the gradient property is implemented as a factor that is multiplied by a magnitude corresponding to the input gesture. For example, a media with a gradient property of 0.5 would require twice the effort as a media with a gradient property of 1.0. In various embodiments, the amount of effort is not linear and the gradient property may map to a non-linear function. In some embodiments, the gradient property is implemented by modeling the media as a surface with physical properties such as friction. In some embodiments, the gradient property may be configured for a media such that the browsing of a collection of shared media will come to a full stop once the media is reached. For example, in some embodiments, a current media with a gradient property of 0.0 will stop the advancement to subsequent media (e.g., the scrolling) at the current media and no amount of extra effort from the received input gesture would have resulted in advancing to the next media. In some embodiments, only a subsequent input gesture will advance past a current media with a gradient property configured to stop advancement.

At 905, the retrieved gradient properties are applied to the magnitude value. In some embodiments, the magnitude value is based in part on the input gesture received at 901 and the gradient properties retrieved at 903. At 905, the gradient properties are applied to the magnitude value to adjust the impact of the input gesture to the current digital media. In some embodiments, the input gesture received at 901 has a corresponding input magnitude value which is modified by the gradient properties of the media. In some embodiments, the corresponding input magnitude value is based on an offset. In some embodiments, the offset is based on the distance between a start location and an end location corresponding to the gesture. In some embodiments, the corresponding input magnitude relates to the distance travelled by the input gesture. For example, the distance travelled may be the distance in a particular direction attributed to the effort of the gesture. In some embodiments, the distance travelled has a corresponding unit such as the number of pixels travelled. In some embodiments, the distance travelled is based on the speed of the gesture and factors from previous gestures. In some embodiments, the momentum associated with the gesture(s) is used to determine the distance travelled. In various embodiments, the magnitude value corresponds to the distance travelled based on the input gesture and the media's gradient properties.

In some embodiments, the browsing of a current media may be accelerated by applying media properties to the input gesture. For example, the distance associated with the input gesture may be magnified once gradient properties are applied to the magnitude value. In some embodiments, the magnitude value is applied to achieve a non-linear advancement to the next media. For example, the distance travelled corresponding to an input gesture may be twice the actual distance based on the media gradient properties. As another example, the distance travelled corresponding to an input gesture may be a fraction of the actual distance based on the media gradient properties.

At 907, the magnitude value is applied to the current digital media in preparation for determining whether to advance from the current media to a sequential available media. In some embodiments, the magnitude value corresponds to an offset and is compared to a boundary value of the media. The offset represents the distance travelled based on the input gesture modified by the media's gradient properties. In some embodiments, the boundary value of the media is based on the size of the current media. For example, the boundary value may be the size of the media in terms of number of pixels along the direction of the input gesture. In some embodiments, the boundary value is based on the dimensions of the foreground of the media. In some embodiments, in the event the distance travelled exceeds the boundary value of the current media, the current digital media is exceeded. In the event the distance travelled does not exceed the size then the current digital media has not been exceeded. In some embodiments, a different unit of distance other than pixels is utilized. For example, units may be in standard or metric units. As another example, units may be based on a unit grid. As a further example, units may be based on the size of the display device.

In some embodiments, the magnitude value is applied to the current digital media along the direction of the input gesture. In some embodiments, the magnitude value is applied to the current digital media along a coordinate axis such that the gesture's impact is locked to a coordinate axis (e.g., vertical and/or horizontal axis). For example, gestures that are slightly off the horizontal axis are treated as a horizontal gesture. Similarly, gestures that are slightly off the vertical axis are treated as a vertical gesture. In some embodiments, the direction of the input gesture is projected to a coordinate axis.

At 909, a determination is made based on the magnitude value and whether the current digital media has been exceeded. In the event the current digital media is not exceeded at 909, the process of FIG. 9 is concluded. In some embodiments, a partial distance travelled by applying the magnitude value is stored and applied to the magnitude value corresponding to a subsequent gesture input. For example, in the event that half the distance required to advance to the next media is determined, then a subsequent input gesture begins at the previous end location. For a subsequent input gesture, the remaining half distance would be required to advance to the next media.

In the event the current digital media is exceeded at 909, the process of FIG. 9 proceeds to 911. At 911, a determination is made whether additional sequential media is available. For example, in the event the current media is the last of the collection of media for display and the input gesture is intended to advance towards the end of the collection, then no sequential media is available. However, in the event the current media is not the last of the collection, then additional sequential media is available. In a similar manner, in the event the input gesture is intended to advance towards the first of the collection, then additional sequential media is available if the current media is not the first media.

In some embodiments, the sequential media may be ordered in more than one dimension. In the event the ordering exists in multiple directions, sequential media is available in the event there is additional media available in the dimension based on the direction of the input gesture. For example, in a scenario with two-dimensional ordered media (e.g., along an x-axis and y-axis), in the event the input gesture is towards the bottom-right corner, additional media is available if the current media is not the media ordered as the bottom-right media.

At 911, in the event no sequential media is available, the process of FIG. 9 is concluded. In the event sequential media is available at 911, the process of FIG. 9 proceeds to 913. At 913, a new current digital media is set by advancing the reference for the current digital media to the next sequential digital media. In some embodiments, the next sequential digital media is determined by the direction of the received input gesture. In some embodiments, the advancement is in the direction associated with the input gesture and may be forward, backwards, or in another direction. In some embodiments, the new current media is displayed. In some embodiments, one digital media is displayed at a time. For example, scrolling the media displays one current media at a time and advancing sets the current digital media to the next media to display. After advancing the media, the process continues back to 903. At 903, the digital media has now been advanced and the gradient properties are retrieved for the new current digital media. In some embodiments, a start location is applied and based on previous input gestures and media properties.

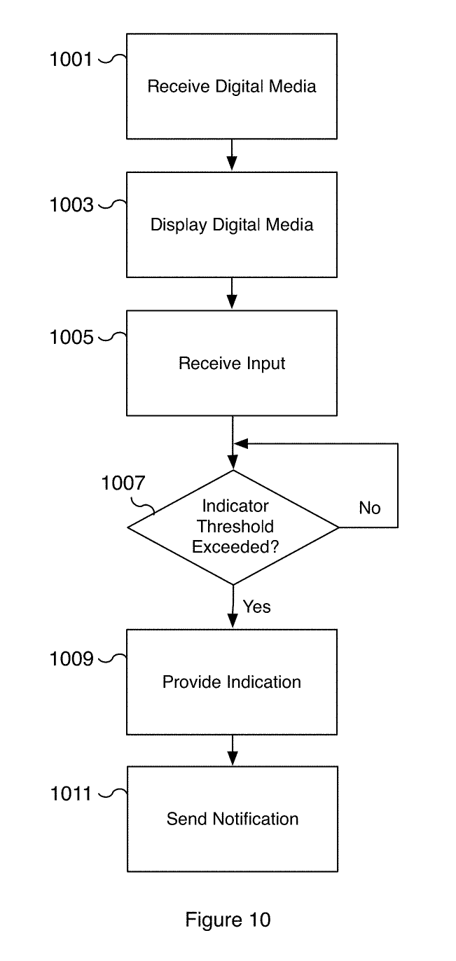

FIG. 10 is a flow diagram illustrating an embodiment of a process for automatically providing digital media feedback. In some embodiments, the process of FIG. 10 is implemented on clients 101, 103, and 105 of FIG. 1. In some embodiments, the process of FIG. 10 is implemented on clients 101, 103, and 105 of FIG. 1 using digital media and properties associated with the digital media received from server 111 over network 107 of FIG. 1. In some embodiments, the properties associated with the digital media are stored in database 121 of FIG. 1. In some embodiments, the digital media is the digital media shared at 305 of FIG. 3.

In the example shown, at 1001, a digital media is received. In some embodiments, the digital media received is digital media shared at 305 of FIG. 3. In some embodiments, the digital media received is part of the plurality of digital media received at 801 of FIG. 8. At 1003, the digital media is displayed on the device. In some embodiments, the displayed digital media is the current digital media displayed at 803 of FIG. 8. In some embodiments, the received and displayed digital media is part of a collection of digital media for browsing. The displayed media of 1003 is the media currently being browsed. At 1005, user input is received. In some embodiments, the input is user input performed when interacting with the media. In some embodiments, the input is user input performed when viewing the media. For example, when users view media, they may pause on the media, focus their view on certain areas of the media, zoom in on certain portions of the media, and repeat a loop of a certain section of the media (e.g., for videos or animations), among other viewing behaviors. In some embodiments, user input is input primarily associated with the viewing experience of the media and not explicit or intentionally created feedback of the media. In some embodiments, the input received at 1005 is input captured related to viewing behavior. In some embodiments, the input received at 1005 is input captured related to browsing behavior. In some embodiments, the user input is passive input. Examples of passive input include the user stopping at a particular media and gazing at the media, a user hovering over a media using a gesture input apparatus (finger, hand, mouse, touchpad, virtual reality interface, etc.), focus as determined by an eye tracker, heat maps as determined by an eye tracker, and other similar forms of passive input. In some embodiments, the user input is active input, such as one or more pinch, zoom, rotate, and/or selection gestures. For example, a user may pinch to magnify a portion of the media. As another example, a user may zoom in on and rotate a portion of the media. In some embodiments, a heat map can be constructed based on the areas of and the duration of focus.

At 1007, the amount of time the input has been detected is compared to an indicator threshold. In some embodiments, the indicator threshold is the minimum amount of time for the input of 1005 to trigger an indication. For example, in the event the indicator threshold is three seconds, a gaze of at least three seconds is required to trigger a gaze indication. In some embodiments, a user may configure the indicator threshold for each of his or her shared media. In some embodiments, the indicator threshold is based on viewing habits of users. For example, a user that quickly browses media may have an indicator threshold of two seconds while a user that browses slower may have an indicator threshold of five seconds. In some embodiments, the indicator threshold is set to correspond to the amount of time that must pass for a user to indicate interest in a media. As another embodiment, the indicator threshold may be different for each media. For example, a very popular media may have a lower indicator threshold than an average media. In some embodiments, the indicator threshold is based in part on the display device. For example, a smartphone with a large display may have a different indicator threshold than a smartphone with a small display. Similarly, a virtual reality headset with a particular field of view may have a different indicator threshold than a display on a smart camera.

At 1007, in the event the indicator threshold has not been exceeded, processing loops back to 1007. At 1007, in the event the indicator threshold is exceeded, processing continues to 1009. At 1009, an indication is provided. In some embodiments, the indication includes an indication software event. In some embodiments, the indication is a cue to the user that the user's input has exceeded the indicator threshold. In some embodiments, the indication corresponds to the amount and form of interest a viewer has expressed in the currently displayed media. In various embodiments, the indicator may be a visual and/or audio indicator. In various embodiments, the indicator is a user interface element or event. For example, an indication corresponding to a gaze may involve a gaze user interface element displayed on the media. As another example, an indication corresponding to a heat map may involve a heat map user interface element overlaid on the media. Areas of the heat map may be colored differently to correspond to the duration of the user's focus on that area. For example, areas that attract high focus may be colored in red while areas that have little or no focus may be transparent. In another example, areas of focus are highlighted or outlined. In some embodiments, the indication is a form of media feedback. For example, the indication provides feedback to the user and/or the sharer that an indication has been triggered.

In some embodiments, an indictor includes a display of the duration of the input. For example, an indicator may include the duration of the input received at 1005, such as the duration of a gaze. In various embodiments, an icon is displayed that provides information related to the user's and other users' indications and is updated when an indication is provided. For example, an icon is displayed corresponding to the number of users that have triggered an indication for the viewed media. In the scenario that five users have triggered a gaze indication, an icon is displayed on the media that displays the number five for each of the past indications received for the media. In the event a user triggers a gaze indication, the icon is updated to reflect the additional gaze indication and now displays the number six.

In some embodiments, a user interface indication continues to display as long as the input is detected. For example, in the event the indicator threshold is configured to three seconds, once a user gazes at a media for at least three seconds, a fireworks visual animation is displayed over the media. The fireworks visual animation continues to be displayed as long as the user continues to gaze at the media. In the event the user stops his or her gaze, for example, by advancing to a different media, the fireworks animation may cease. As another example, as long as a gaze indication is detected, helium balloon visuals are rendered over the gazed media and are animated to drift upwards.

In some embodiments, the provided indication is also displayed for more than one user. For example, the provided indication or a variation of the indication is displayed for other users viewing the same media. In some embodiments, users viewing the same media on their own devices receive an indication corresponding to input received from other users. In some embodiments, the provided indication is based on the number of users interacting with the media. For example, an animation provided for an indication may increase in intensity (e.g., increased fireworks or additional helium balloon visuals) as additional users interact with the media.

At 1011, a notification corresponding to the indication is sent. In some embodiments, the notification is a network notification sent from the device to a media sharing service over a network such as the Internet. In some embodiments, the network notification is sent to server 111 over network 107 of FIG. 1. The notification may include information associated with the user's interaction with the media. For example, the notification may include information on the type of input detected, the duration of the input, the user's identity, the timestamp of the input received, the location of the device at the time of the input, and feedback from the user. Examples of feedback include responses to the media such as comments, stickers, annotations, emojis, audio messages tagged to the media, media shared in response to the feedback, among others. For example, a user may add a heart emoji and the comment “Remember this?” to the current media. In some embodiments, the network notification may include the comment, the location the comment was placed on the media, the emoji, the location the emoji was placed on the media, the user's identity, the user's location when the emoji and/or comment was added, the time of day the user added the emoji and/or comment, the type of input (e.g., a gaze indication, a focus indication, etc.), the duration of the input, and any additional information related to the input (for example, heat maps associated with the gaze). In various embodiments, the network notification is used to distribute the indication to other users, for example, other users viewing the same media.

In some embodiments, the notification is sent to inform the owner of the media about activity associated with a shared media. For example, the notification may inform the user of interactions such as viewing, sharing, annotations, and comments added to a shared media. In some embodiments, the notifications are used to identify media that was not desired to be shared. For example, in the event a media was inadvertently shared, a notification is received when another user accesses (e.g., views) the shared media. The notification may contain information including the degree to which the media was shared and the type of activity performed on the media. Using the notification information, the owner of the media may trace the interaction on the media and determine the extent of the distribution of the sharing. The notification may include information for the user to address any security deficiencies in the automatic or manual sharing of digital media.

FIG. 11A is a diagram illustrating an embodiment of a user interface for digital media browsing and feedback. In some embodiments, the user interface of FIG. 11A is displayed on clients 101, 103, and 105 of FIG. 1. In some embodiments, the diagram of FIG. 11A is implemented on clients 101, 103, and 105 of FIG. 1 using digital media and properties associated with the digital media received from server 111 over network 107 of FIG. 1. In some embodiments, the digital media is digital media shared at 305 of FIG. 3.

In the example shown in FIG. 11A, user interface 1101 is displayed by a device for browsing media. User interface 1101 includes title bar 1103, displayed media 1105, status bar 1107, browsing indicators 1109, media feedback 1111, indication icon 1113, and feedback button 1115. In the example shown, user interface 1101 displays a digital media, such as a shared photo, as displayed media 1105. In some embodiments, displayed media 1105 is digital media shared at 305 of FIG. 3. In some embodiments, title bar 1103 includes a media title (“Jackson”), a location (“Lands End—San Francisco, Calif.”), and a quit icon (a button with an “x”). In various embodiments, title bar 1103 allows access to additional functionality and may include additional icons to access additional functionality.

In some embodiments, user interface 1101 includes browsing indicators 1109. Browsing indicators 1109 correspond to the current displayed media's relationship to the collection of media being browsed. In the example, browsing indicators 1109 are made up of a collection of circles with one circle that is a large outline. In some embodiments, the large outlined circle indicates the relationship of the current media to the sequence of shared media. In some embodiments, different circles of browsing indicators 1109 may be highlighted differently (in bold, larger, smaller, using different colors, translucent, transparent, different shading, etc.) to emphasize different media. For example, media with user feedback may be highlighted differently.

In some embodiments, status bar 1107 includes indication icon 1113, feedback button 1115, and a more icon to access additional functionality. For example, status bar 1107 includes indication icon 1113 that is a gaze icon corresponding to gazes for the current media. In the example shown, the indication icon 1113 depicted in status bar 1107 is a balloon icon with the number 1. The number indicates the number of users that have triggered a gaze indication for the media. In some embodiments, the gaze icon may have a different visual design and may include additional gaze indication information, such as a profile picture, icon, and/or username of each user that has triggered a gaze indication. The gaze icon may also include a number corresponding to the duration of the indication. In some embodiments, selecting indication icon 1113 allows the user to explore additional gaze indication feedback, such as which users triggered the gaze and for how long. Selecting indication icon 1113 may also provide an interface to review any additional feedback left by those users. Status bar 1107 additionally includes feedback button 1115. In the example shown, feedback button 1115 includes the text “Add reaction” and may be selected to leave feedback on the current shared media displayed.

In the example shown, media feedback 1111 is presented as a gaze visual cue. Media feedback 1111 includes the text “You gazed” and an emoji of eyes corresponding to a gaze visual. In some embodiments, a different visual cue is displayed corresponding to a different indication. For example, a different visual cue may be displayed corresponding to a different form of feedback such as a comment, annotation, emoji, hover zone, a zone based on eye tracking, sticker, etc. Media feedback 1111 is one example of a type of feedback (such as gaze indication) and additional types of feedback may exist. In some embodiments, the positioning of media feedback 1111 is based on focal point of the gaze.

In some embodiments, user interface 1101 is displayed to a user viewing a shared photo after the user has triggered a gaze indication. In some embodiments, the gaze indication is triggered using the process described in FIG. 10. In the example shown, title bar 1103 includes information that the user is viewing a photo of a contact named “Jackson” taken at the location “Lands End—San Francisco, Calif.” Once the user has viewed the photo for at least a threshold amount of time corresponding to an indication threshold, an indication is provided. In some embodiments, the indication corresponds to media feedback 1111 and indication icon 1113. The gaze indication of media feedback 1111 is overlaid on top of the shared photo of displayed media 1105. Media feedback 1111 and/or indication icon 1113 are presented and help to inform the viewer that an indication has been triggered. In some embodiments, feedback button 1115 labeled “Add reaction” is displayed and selectable only once an indication is presented. For example, a gaze indication, indication icon, and feedback button may all be displayed once the indication threshold is met. Selecting the feedback button 1115 presents the user with a feedback user interface. In various embodiments, the display of feedback button 1115 is not tied to an indication. For example, feedback button 1115 may be presented as soon as a user browses to displayed media 1105 and does not require viewing the media for at least an indication threshold amount of time. In some embodiments, feedback button 1115 has a corresponding feedback threshold and is presented only once a user views the media for at least a feedback threshold amount of time. For example, no feedback button is displayed while a user is quickly advancing through the shared media. However, once the user stops on a media for at least a feedback threshold of time, a feedback button is displayed.

FIG. 11B is a diagram illustrating an embodiment of a user interface for digital media browsing and feedback. In some embodiments, the user interface of FIG. 11B is displayed on clients 101, 103, and 105 of FIG. 1. In some embodiments, the diagram of FIG. 11B is implemented on clients 101, 103, and 105 of FIG. 1 using digital media and properties associated with the digital media received from server 111 over network 107 of FIG. 1. In some embodiments, the digital media is digital media shared at 305 of FIG. 3.

In the example shown in FIG. 11B, user interface 1121 is displayed by a device for browsing media. User interface 1121 includes title bar 1123, displayed media 1125, status bar 1127, browsing indicators 1129, media icon 1128, media feedback 1131, pending media feedback 1133, and media feedback cancellation icon 1135. In the example shown, user interface 1121 displays a digital media, such as a shared photo, as displayed media 1125. In some embodiments, displayed media 1125 is digital media shared at 305 of FIG. 3. In some embodiments, title bar 1123 includes a configure icon (displayed as a wrench) to configure user settings for sharing and viewing media, a media title (“Jackson”), a location (“Lands End—San Francisco, Calif.”), and a quit icon (a button with an “x”). In various embodiments, title bar 1123 allows access to additional functionality and may include additional icons to access additional functionality. In some embodiments, status bar 1127 includes media icon 1128 to denote additional information related to displayed media 1125. In various embodiments, media icon 1128 may be used to denote that displayed media 1125 has feedback, has been shared, and/or has additional feedback that may be revealed. In some embodiments, media icon 1128 is an indication icon.

In some embodiments, user interface 1121 includes an embodiment of browsing indicators 1129. Browsing indicators 1129 correspond to the current displayed media's relationship to the collection of sequential media being browsed. In the example, browsing indicators 1129 are made up of a collection of circles and a numeric display above the column of circles. In some embodiments, the numeric display is associated with the collection of shared media. In some embodiments, the numeric display is associated with the current displayed media 1125. For example, browsing indicators 1129 includes a user interface element displaying the number 4, which indicates that there are four different forms of feedback associated with displayed media 1125. In some embodiments, the circle that is outlined indicates the relationship of the current media to the sequence of shared media. In some embodiments, different circles of browsing indicators 1129 may be highlighted differently (in bold, larger, smaller, using different colors, translucent, transparent, different shading, etc.) to emphasize different media. For example, media with user feedback may be in color while media without feedback is gray.

In the example shown, media feedback 1131 is presented as a gaze visual cue corresponding to a gaze input performed by the user and shared with the original owner of displayed media 1125. Media feedback 1131 includes the text “You gazed” and an emoji of eyes corresponding to a gaze visual. In some embodiments, a different visual cue is displayed corresponding to a different indication. Media feedback 1131 is one example of a type of feedback (such as gaze indication) and additional types of feedback may exist. In some embodiments, pending media feedback 1133 corresponds to a user interface element that notifies the user of the current feedback received. In the example shown, pending media feedback 1133 displays “gazing . . . ” and an emoji of eyes. Pending media feedback 1133 corresponds to a pending gaze that has not exceeded a gaze threshold time to trigger a media feedback. In some embodiments, the background of pending media feedback 1133 is a background color corresponding to the user. For example, the background color of pending media feedback 1133 is the same color as the background color of media feedback 1131 since both are created by the same user. In the example shown, the amount the background of pending media feedback 1133 is colored in is based on the duration of the gaze. In some embodiments, the background of pending media feedback 1133 is completely filled in when the gaze threshold has been reached. In the example shown, media feedback cancellation icon 1135 displays the comment “Nope!” and an emoji corresponding to stopping an action. Media feedback cancellation icon 1135 also include the text “Flick to cancel” above the user interface bubble element. In some embodiments, media feedback cancellation icon 1135 is displayed while user feedback, such as a gaze, is received. A user may flick media feedback cancellation icon 1135 to cancel the pending media feedback. For example, the user may flick media feedback cancellation icon 1135 off the screen to cancel the gaze feedback associated with pending media feedback 1135. In some embodiments, media feedback cancellation icon 1135 receives a touch, a click, or other similar user input to trigger cancelling pending media feedback 1133.

FIG. 11C is a diagram illustrating an embodiment of a user interface for digital media browsing and feedback. In some embodiments, the user interface of FIG. 11C is displayed on clients 101, 103, and 105 of FIG. 1. In some embodiments, the diagram of FIG. 11C is implemented on clients 101, 103, and 105 of FIG. 1 using digital media and properties associated with the digital media received from server 111 over network 107 of FIG. 1. In some embodiments, the digital media is digital media shared at 305 of FIG. 3. In some embodiments, media feedback generated in FIG. 11A and/or FIG. 11B is shown in Figure 11C.

In the example shown in FIG. 11C, user interface 1141 is displayed by a device for browsing media and feedback. User interface 1141 includes title bar 1143, displayed media 1145, status bar 1147, browsing indicators 1149, indication icon 1153, media time information 1155, and media feedback 1161, 1163, 1165. In the example shown, user interface 1141 displays a digital media, such as a shared photo, as displayed media 1145. In some embodiments, displayed media 1145 is digital media shared at 305 of FIG. 3. In some embodiments, title bar 1143 includes a flag icon for marking the media, media title (“Me”), a location (“Yosemite National Park”), and a quit icon (a button with an “x”). In some embodiments, status bar 1147 includes indication icon 1153 and media time information 1155. In some embodiments, indication icon 1153 denotes the number of media feedback for the displayed media 1145. In some embodiments, media time information 1155 displays time information associated with displayed media 1145. For example, media time information 1155 may display the share timestamp of the media or the creation timestamp of the media depending on configuration. In the example shown, media time information 1155 includes the text “2 h ago” to indicate the media was shared two hours ago. In some embodiments, media feedback 1161, 1163, 1165 are generated using the user interfaces of FIG. 11A and/or FIG. 11B.

In some embodiments, media feedback such as gaze feedback is displayed on displayed media 1145. In the example shown, media feedback 1161, 1163, 1165 are gaze indication feedback corresponding to gaze feedback when other users viewed the displayed media 1145. Each media feedback displays the user associated with the feedback and the time the feedback was created or performed. In some embodiments, the media feedback includes the duration of the feedback, for example, how long a user gazed at a media. Media feedback 1161 is a gaze indication feedback and displays the user “Jackson Deane ” and “1 m” to indicate that user Jackson Deane gazed at the shared media one minute ago. Media feedback 1163 is a gaze indication feedback and displays the user “Doug Imbruce” and “1 m” to indicate that user Doug Imbruce gazed at the shared media one minute ago. Media feedback 1165 is a gaze indication feedback and displays the user “Rob” and “1 m” to indicate that user Rob gazed at the shared media one minute ago. In the example shown, indication icon 1153 includes the number “3” indicating that the displayed shared media has three instances of gaze indication feedback.

In some embodiments, user interface 1141 includes browsing indicators 1149. Browsing indicators 1149 correspond to the current displayed media's relationship to the collection of media being browsed. In the example, browsing indicators 1149 are made up of a collection of circles with one circle that is a large outline. In some embodiments, the large outlined circle indicates the relationship of the current media to the sequence of shared media. In some embodiments, different circles of browsing indicators 1149 may be highlighted differently (in bold, larger, smaller, using different colors, translucent, transparent, different shading, etc.) to emphasize different media. For example, media with user feedback may be highlighted differently. In some embodiments, browsing indicators 1149 alerts the user to upcoming media feedback with a visual indicator, shown as a colored circle. In some embodiments, media without feedback is represented as a grey circle. In some embodiments, browsing indicators 1149 includes a numeric display used to display information for the collection of shared media or the shared media itself.

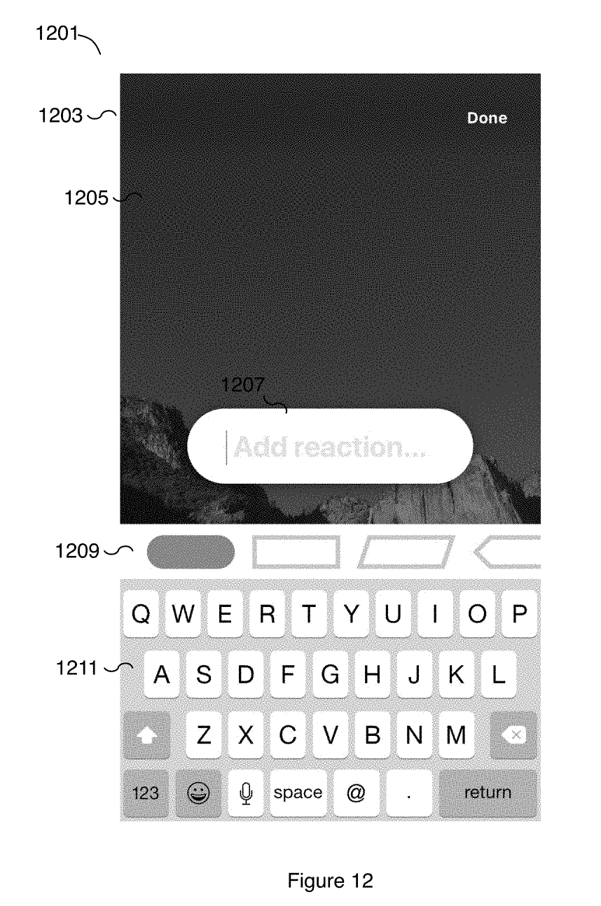

FIG. 12 is a diagram illustrating an embodiment of a user interface for providing digital media feedback. In some embodiments, the user interface of FIG. 12 is displayed on clients 101, 103, and 105 of FIG. 1. In some embodiments, the diagram of FIG. 12 is implemented on clients 101, 103, and 105 of FIG. 1 using digital media and properties associated with the digital media received from server 111 over network 107 of FIG. 1. In some embodiments, the digital media is digital media shared at 305 of FIG. 3. In some embodiments, the user interface of FIG. 12 is presented when selecting a feedback button such as feedback button 1115 of FIG. 11A.

In the example shown in FIG. 12, user interface 1201 is displayed by a device for adding feedback while browsing media. User interface 1201 includes title bar 1203, displayed media 1205, feedback dialog 1207, feedback visual editor 1209, and virtual keyboard 1211. In the example shown, user interface 1201 displays a media, such as a shared photo, as displayed media 1205. In some embodiments, displayed media 1205 is digital media shared at 305 of FIG. 3. In some embodiments, title bar 1203 includes a media title and location. In various embodiments, title bar 1203 allows access to additional functionality and may include additional icons to access additional functionality. In the example shown, title bar 1203 includes a done button labeled “Done.”

In some embodiments, a user may use feedback dialog 1207, feedback visual editor 1209, and virtual keyboard 1211 of user interface 1201 to add feedback to a media. Using virtual keyboard 1211, a user may add a comment using text and/or emoji. The comment is displayed in feedback dialog 1207. Feedback visual editor 1209 may be used to customize the visual look of the feedback. In the example shown, feedback visual editor 1209 presents a variety of shapes to apply to the outline of the feedback including an oval, rectangle, parallelogram, hexagram, etc. The user may scroll feedback visual editor 1209 to reveal additional options. In some embodiments, feedback visual editor 1209 includes a selection of colors, stickers, backgrounds, patterns, animations, and other visual options for customizing the user's feedback.

In some embodiments, the user selects a completion button, such as the done button of title bar 1203 when the comment's content and design are complete. In some embodiments, the user may then select the location of the media feedback to place on the shared media. For example, the media feedback is overlaid on the shared media and the user may drag the feedback to adjust the location where it is displayed. In some embodiments, different user inputs, such as different gestures (drag, pinch, rotate, etc.), may be used to move, resize, and/or rotate the feedback. In some embodiments, the initial location and size are selected based on the contents of the media and other feedback for the media. For example, a default location may be selected that does not block the foreground of the image. As another example, a default location may be selected such that the sequence of feedback is visually presented as a conversational thread. In some embodiments, the location of the feedback is anchored to a relevant location on the media based on the context of the feedback.

In some embodiments, once the feedback adjustments are complete, a notification is sent. In some embodiments, the notification is used to inform other users of the newly created feedback for the shared media. In some embodiments, the notification may be a network notification sent to a media sharing server such as server 111 of FIG. 1. In various embodiments, the feedback is presented to users when the shared media is viewed. In some embodiments, users receive an alert, such as a text message, email, notification, etc. when a feedback is created.

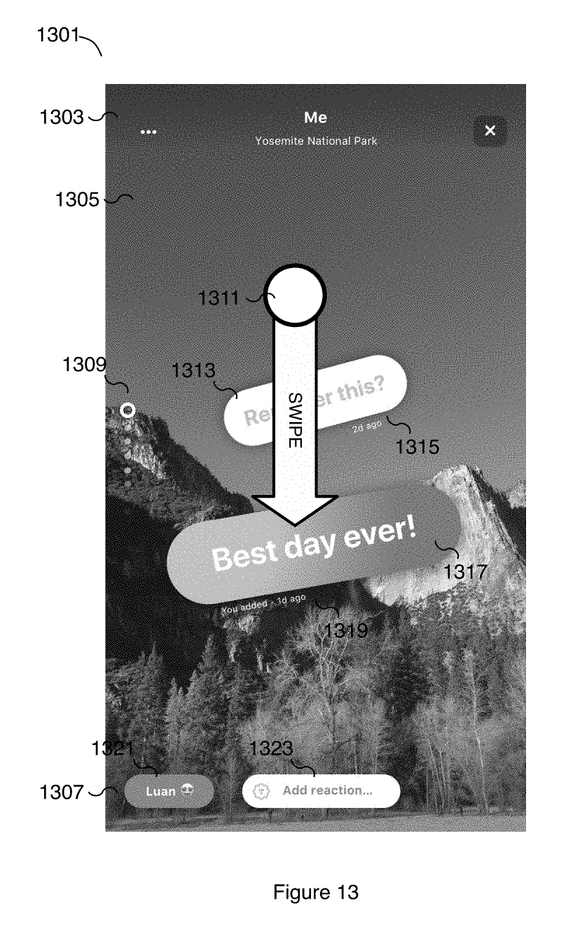

FIG. 13 is a diagram illustrating an embodiment of a user interface for digital media browsing and feedback. In some embodiments, the user interface of FIG. 13 is displayed on clients 101, 103, and 105 of FIG. 1. In some embodiments, the diagram of FIG. 13 is implemented on clients 101, 103, and 105 of FIG. 1 using digital media and properties associated with the digital media received from server 111 over network 107 of FIG. 1. In some embodiments, the digital media is digital media shared at 305 of FIG. 3. In some embodiments, the user interface of FIG. 13 is presented after feedback has been created for a shared media. In some embodiments, the feedback is created and shared using the user interface of FIG. 12.

In the example shown in FIG. 13, user interface 1301 is displayed by a device for browsing media. User interface 1301 includes title bar 1303, displayed media 1305, status bar 1307, browsing indicators 1309, media feedback 1313, media feedback context 1315, media feedback 1317, media feedback context 1319, media feedback icon 1321, and feedback button 1323. In the example shown, user interface 1301 displays a media, such as a shared photo, as displayed media 1305. In some embodiments, displayed media 1305 is digital media shared at 305 of FIG. 3. In some embodiments, title bar 1303 includes a media title (“Me”) and location (“Yosemite National Park”), a quit icon, and a more icon for accessing additional functionality. In some embodiments, the media title (“Me”) indicates the owner of the shared photo displayed. In some embodiments, status bar 1307 includes a display of users who have interacted with the media and functionality for the current user to add feedback. For example, status bar 1307 includes media feedback icon 1321, an icon denoting that user “Luan” has left an emoji feedback for the current media. Status bar 1307 additionally includes feedback button 1323, which includes the text “Add reaction,” and may be used for adding feedback to the media. In some embodiments, the user icons displayed in status bar 1307 correspond to the authors of the media feedback displayed, such as media feedback 1313.

In some embodiments, user interface 1301 is implemented on a smartphone device with a touch screen and users may interact with user interface 1301 using touch gestures such as swipe 1311. In the example shown, the user has performed swipe gesture 1311 to display the feedback associated with the current media. By performing swipe gesture 1311, user interface 1301 displays media feedback 1313, media feedback context 1315, media feedback 1317, and media feedback context 1319. In the example, media feedback 1313 is a comment left by another user and media feedback 1317 is a response to media feedback 1313 left by the current user viewing the media. Media feedback context 1315, which includes the text “2 d ago,” is a timestamp denoting when the feedback of media feedback 1313 was created. In some embodiments, media feedback context 1315 may be used to provide context for feedback such as the creation date, last view date, last modified date, author, etc. In the example shown, the context of media feedback context 1315 indicates the feedback was created two days ago. In some embodiments, media feedback icon 1321 displayed in status bar 1307 indicates the author of the media feedback 1313. In the example shown, the author of media feedback 1313 is the user “Luan” as indicated by media feedback icon 1321. Media feedback context 1319 includes the text “You added—1 d ago” and indicates the current user created media feedback 1317 one day ago. In some embodiments, media feedback by the current user, such as media feedback 1317, may be created by selecting feedback button 1323.

In some embodiments, input gesture(s) may be used to manipulate the display of media feedback. In the example shown, swipe gesture 1311 is used to advance through the display of feedback associated with the media. For example, during the duration of swipe 1311, first media feedback 1313 and media feedback context 1315 are displayed and only subsequently are media feedback 1317 and media feedback context 1319 displayed. In some embodiments, an input gesture manipulates the timeline of the feedback. As the user moves forward and backward through the timeline, media feedback is displayed based on the timestamp associated with the media feedback and the current position on the timeline. In some embodiments, all current and past feedback corresponding to the timeline are displayed. For example, as the timeline is advanced, past feedback continues to be displayed as new feedback is added. In some embodiments, only the current feedback corresponding to a current window of the timeline is displayed. For example, as the timeline is advanced, past feedback fades away and new feedback is displayed. In some embodiments, audio, visual, and/or tactile feedback is provided as the media feedback is displayed.

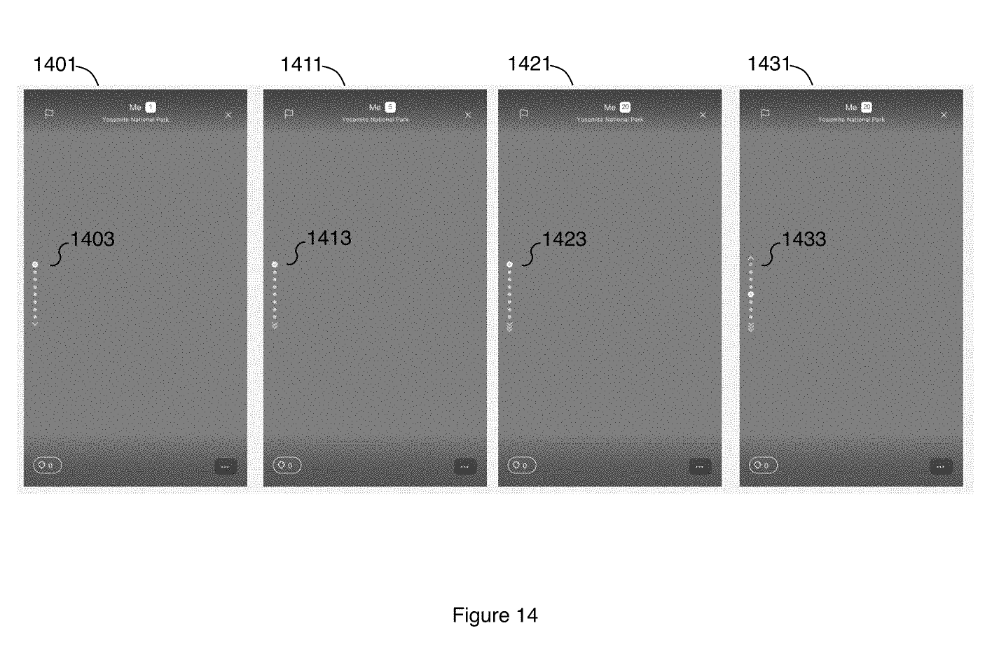

FIG. 14 is a diagram illustrating various embodiments of user interface browsing indicators for digital media browsing and feedback. In some embodiments, elements of the user interfaces of FIG. 14 are displayed on clients 101, 103, and 105 of FIG. 1. In some embodiments, elements of the diagram of FIG. 14 are implemented on clients 101, 103, and 105 of FIG. 1 using digital media and properties associated with the digital media received from server 111 over network 107 of FIG. 1. In some embodiments, the digital media browsed using the browsing indicators includes digital media shared at 305 of FIG. 3. In some embodiments, elements of the user interfaces of FIG. 14 are incorporated into the user interfaces of FIGS. 11A, 11B, 11C, and 13 for digital media browsing and feedback.

In the example of FIG. 14, four different states of user interface browsing indicators are shown. User interfaces 1401, 1411, 1421, and 1431 each correspond to a user interface for browsing digital media. In some embodiments, the digital media browsed is displayed in user interfaces 1401, 1411, 1421, and 1431. User interfaces 1401, 1411, 1421, and 1431 each include corresponding browsing indicators 1403, 1413, 1423, and 1433 representing one or many the different states available for the browsing indicators. In some embodiments, browsing indicators 1403, 1413, 1423, and 1433 are used to help navigate the current displayed media from among the collection of shared sequential media. In some embodiments, browsing indicators 1403, 1413, 1423, and 1433 include indicators, shown as circles, that correspond to shared media. In various embodiments, a current media indicator, shown as a larger filled circle, corresponds to the current displayed media. The placement of the current media indicator with respect to other indicators provides information on the position where the current displayed media resides in the collection of sequential shared media. For example, current media indicators of browsing indicators 1403, 1413, and 1423 correspond to the current displayed media as the first of the collection of shared media. As another example, current media indicator of browsing indicators 1433 indicates that the current displayed media is not the first media and is displayed only after advancing from the first media towards the end of the collection of shared media.

In some embodiments, browsing indicators 1403, 1413, 1423, and 1433 include arrow icons above and below the circle-shaped media indicators. In some embodiments, the arrows indicate a rough estimate of the number of additional media that exists in the direction of the arrow. In some embodiments, the more arrows displayed, the more digital media that exists in the direction of the arrow. For example, the collection of shared media for user interface 1401 has fewer shared media than the user interface 1411 since browsing indicators 1403 includes one downward facing arrow while browsing indicators 1413 includes two downward facing arrows. Browsing indicators 1423 of user interface 1421 includes three downward facing arrows indicating that many more media exist than for user interfaces 1401 and 1411 in the event the user advances the browsing in the direction of the arrows. Browsing indicators 1433 of user interface 1431 includes an upwards arrow and three downward arrows indicating roughly that three times as many media exist in the event the user advances downwards than upwards. In some embodiments, different circles of browsing indicators 1403, 1413, 1423, and 1433 may be highlighted differently (in bold, larger, smaller, using different colors, translucent, transparent, different shading, etc.) to emphasize different media. For example, media with user feedback may be highlighted differently.

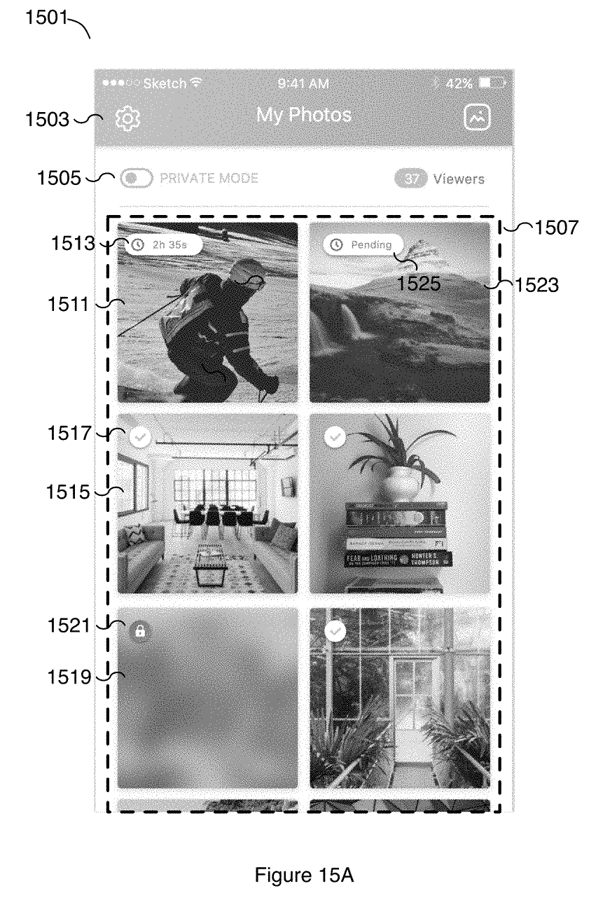

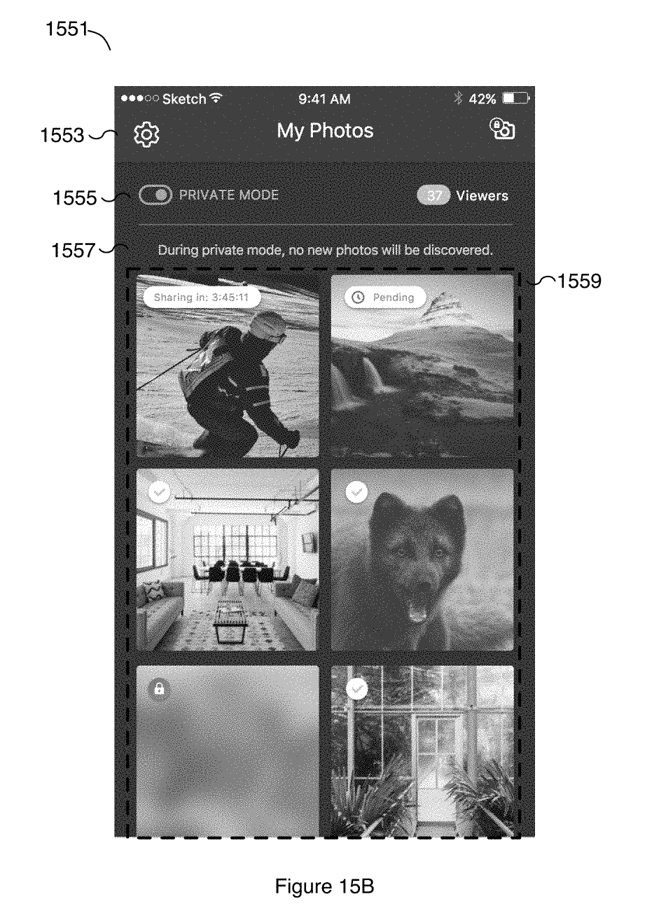

FIGS. 15A and 15B are diagrams illustrating embodiments of user interfaces for sharing digital media. In some embodiments, the user interfaces of FIG. 15A and FIG. 15B are displayed on clients 101, 103, and 105 of FIG. 1. In some embodiments, the diagrams of FIG. 15A and FIG. 15B are implemented on clients 101, 103, and 105 of FIG. 1 using digital media and properties associated with the digital media received from server 111 over network 107 of FIG. 1. In some embodiments, the digital media is digital media detected at 301 of FIG. 3 and analyzed and marked at 303 of FIG. 3. In some embodiments, the digital media is also digital media shared at 305 of FIG. 3.

In the example shown in FIG. 15A, user interface 1501 is displayed by a device for sharing media. User interface 1501 includes title bar 1503, private mode switch 1505, and presentation grid 1507. Presentation grid 1507 includes media thumbnails 1511, 1515, 1519, and 1523. In some embodiments, media thumbnails 1511, 1515, 1519, and 1523 correspond to media detected and marked as desirable for sharing or not desirable for sharing. Overlaid on top of each media thumbnails is a share status icon. Media thumbnails 1511, 1515, 1519, and 1523 include corresponding share status icons. In some embodiments, different share status icons depict the sharing status of the corresponding media. As an example, media thumbnail 1515 includes shared icon 1517. Shared icon 1517 indicates the media associated with the icon is shared with other users. As another example, media thumbnail 1519 includes private icon 1521. Private icon 1521 indicates the media associated with the icon is private and not shared.

In some embodiments, media thumbnails are presented with a release and/or pending icon. As an example, media thumbnail 1511 includes release icon 1513. Release icon 1513 indicates the media associated with the icon is marked shared but has not been released for sharing. In some embodiments, release icon 1513 includes a countdown to the time the corresponding media will be released. For example, release icon 1513 includes a clock icon and the text “2 h 35 s” indicating the media will be released for sharing in two hours and thirty-five seconds. In some embodiments, the release icon displays a countdown until the media will be released. In some embodiments, the release icon displays a countdown to the time when the media will have the first opportunity to be released. In some embodiments, the release icon displays the time of the release. In some embodiments, the release of a media corresponds to releasing the media for sharing with other users. In some embodiments, once a media is released, it enters a state of pending sharing before it may be viewed by other other users. For example, a media may be pending sharing in the event the media is marked available for sharing but the media is not yet shared with other users. Examples of when media may be pending may include a scenario where the media has not been uploaded for sharing (e.g., the device does not have network connectivity) and a scenario where other users have not downloaded or viewed the media. In the user interface of 1501, media thumbnail 1523 includes pending icon 1525. Pending icon 1525 indicates the media has been released and is pending sharing. For example, the media corresponding to media thumbnail 1523 may be waiting for processing resources for uploading to a media server.

In some embodiments, user interface 1501 includes private mode switch 1505. Private mode switch 1505 may be toggled to turn off the automatic sharing of digital media. For example, in the event private mode is enabled, one or more steps of FIG. 3 for automatically sharing desired digital media may be paused or not run. As another example, in the event private mode is enabled, new media may not be detected. In some embodiments, in the event private mode is enabled, media pending sharing or media marked for sharing but not released will not be shared. In some embodiments, in the event private mode is enabled, the user interface of FIG. 15B is shown. In some embodiments, in the event private mode is enabled, the background of the user interface is changed as a visual cue to the user.

In the example shown in FIG. 15B, user interface 1551 is displayed by a device for sharing media in the event private mode is enabled. User interface 1551 includes title bar 1553, private mode switch 1555, private mode message 1557, and presentation grid 1559. In some embodiments, user interface 1551 includes private mode message 1557 to inform the user that private mode is active. Private mode message 1557 includes the message “During private mode, no new photos will be discovered.” In some embodiments, in the event private mode is enabled, digital media is no longer automatically shared. In some embodiments, private mode switch 1555 may be toggled to turn on the automatic sharing of digital media. In some embodiments, in the event private is disabled, the user interface of FIG. 15A is displayed.

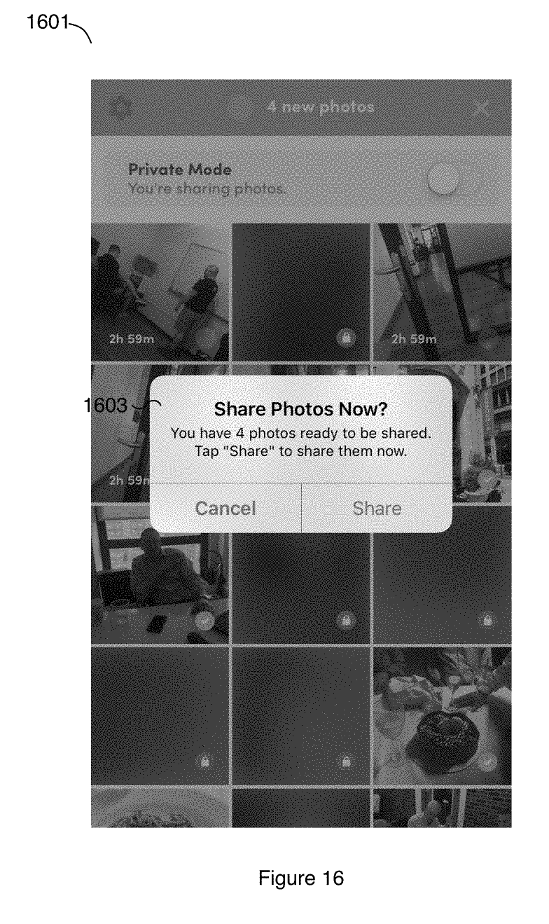

FIG. 16 is a diagram illustrating an embodiment of a user interface for sharing digital media. In some embodiments, the user interface of FIG. 16 is displayed on clients 101, 103, and 105 of FIG. 1. In some embodiments, the diagram of FIG. 16 is implemented on clients 101, 103, and 105 of FIG. 1. In some embodiments, the digital media is digital media detected at 301 of FIG. 3, analyzed and marked at 303 of FIG. 3, and shared at 305 of FIG. 3. In some embodiments, the user interface of FIG. 16 is presented to the user when the user inputs a gesture to share media. In some embodiments, the user interface of FIG. 16 is presented to the user when the user performs an input to share media from the user interface of FIG. 15A. For example, a user performing a “shake” gesture when presented with the user interface of FIG. 15A may be presented with the user interface of FIG. 16.

In some embodiments, media marked for sharing is not released until a time delay has passed. The inclusion of a time delay allows the user to override the automatic sharing of digital media. In some embodiments, the time delay has a corresponding release countdown timer. In the event a user desires to bypass the release countdown for sharing photos, the user may performing a share now gesture and/or select the share now functionality. In some embodiments, the share now functionality corresponds to bypassing a time delay for sharing media. For example, in some embodiments, a share now gesture is the “shake” gesture. As another example, a button is presented to the user to allow the user to perform the share now functionality. In some embodiments, in the event the share now functionality is triggered, the user interface of FIG. 16 is presented.

In the example shown in FIG. 16, user interface 1601 is displayed by a device for confirming the immediate sharing of media. User interface 1601 includes sharing confirmation dialog 1603. In the example shown, sharing confirmation dialog 1603 includes the title “Share Photos Now?” and the text “You have 4 photos ready to be shared. Tap ‘Share’ to share them now.” Sharing confirmation dialog 1603 includes cancel and share buttons. In some embodiments, in the event the user selects “share” corresponding to the share button, the media pending release is released for sharing and any countdowns are completed and set to zero. In some embodiments, all pending media are shared. In some embodiments, only the media selected is applied to the share now functionality. In the example shown in FIG. 16, four new photos are available for sharing. In the event the user selects the share button of sharing confirmation dialog 1603, the four photos are immediately shared. In the event the user selects the cancel button of sharing confirmation dialog 1603, the user interface does not share the photos and the user interface may return to its previous state prior to initiating the share now functionality. In some embodiments, the previous state is the user interface of FIG. 15A.

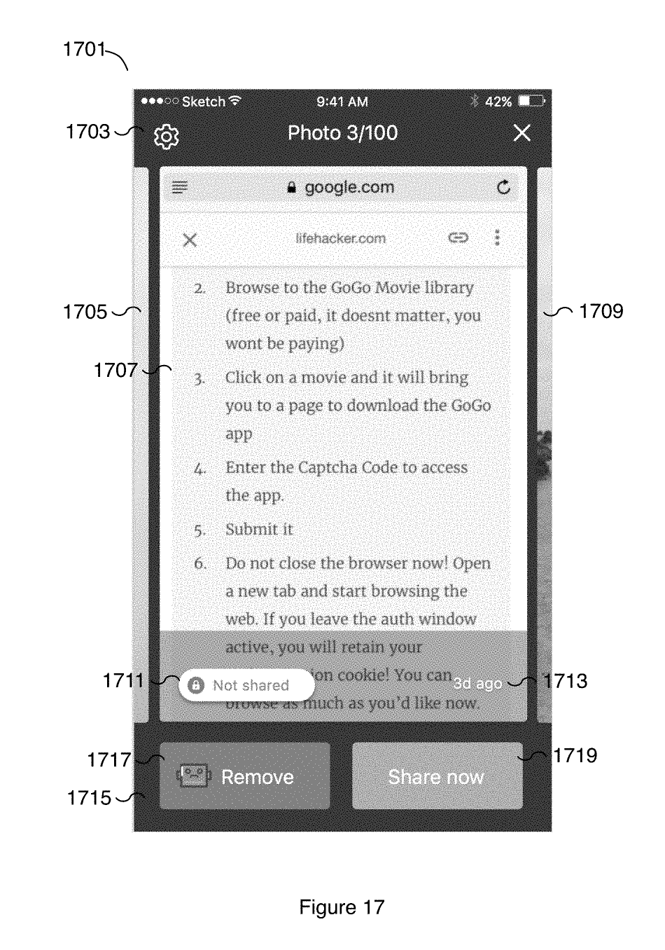

FIG. 17 is a diagram illustrating an embodiment of a user interface for sharing digital media. In some embodiments, the user interface of FIG. 17 is displayed on clients 101, 103, and 105 of FIG. 1. In some embodiments, the diagram of FIG. 17 is implemented on clients 101, 103, and 105 of FIG. 1. In some embodiments, the digital media is digital media detected at 301 of FIG. 3 and analyzed and marked at 303 of FIG. 3. In some embodiments, the digital media is also the digital media shared at 305 of FIG. 3. In some embodiments, the user interface of FIG. 17 is presented after selecting a specific media presented is the user interface of FIG. 15A.

In the example shown in FIG. 17, user interface 1701 is displayed by a device for sharing media. User interface 1701 includes title bar 1703, displayed media 1707, previous media 1705, next media 1709, share icon 1711, media time information 1713, and share action panel 1715. In the example shown, user interface 1701 displays a media, such as a detected, analyzed, and marked photo, as displayed media 1707. In some embodiments, displayed media 1707 is digital media analyzed and marked at 303 of FIG. 3. In some embodiments, title bar 1703 includes a configuration icon (shown as a gear icon), a media label, and a quit icon (a button with an “x”). In the example shown, media label displays “Photo 3/100” indicating displayed media 1707 is the third media of 100 analyzed and marked media. Overlaid on displayed media 1707 are share icon 1711 and media time information 1713. Share icon 1711 displays the share status of the displayed media. For example, share icon 1711 displays that display media 1707 is media marked as not shared. Media time information 1713 displays the time information associated with displayed media 1707. In the example shown, media time information displays the creation date of the media.

In the example shown in FIG. 17, share action panel 1715 includes two buttons, remove button 1717 and share now button 1719. Displayed media 1707 is a screenshot and not desired to be shared. From share action panel 1715 of user interface of 1701, the user may select remove button 1717 to remove displayed media 1707 from the collection of analyzed and marked media. In some embodiments, removing the media deletes the media from the device. In some embodiments, removing the media removes the media from the media sharing application but does not delete the media from the device. In some embodiments, the remove button 1717 removes media prior to the media being made available for sharing. From share action panel 1715 of user interface of 1701, the user may alternatively select share now button 1719. Share now button 1719 releases the media for immediate sharing. In some scenarios, the current displayed media may be marked for sharing but not yet released. In the event the media is marked for sharing but not yet released, selecting share now button 1719 releases the media and shares it immediately. In some embodiment, the sharing is performed at the next opportune time, for example, when the device has network connectivity, the application is granted network and/or processing resources for uploading media, etc. In some embodiments, the share now button 1719 invokes share now functionality to bypass a time delay for releasing media.

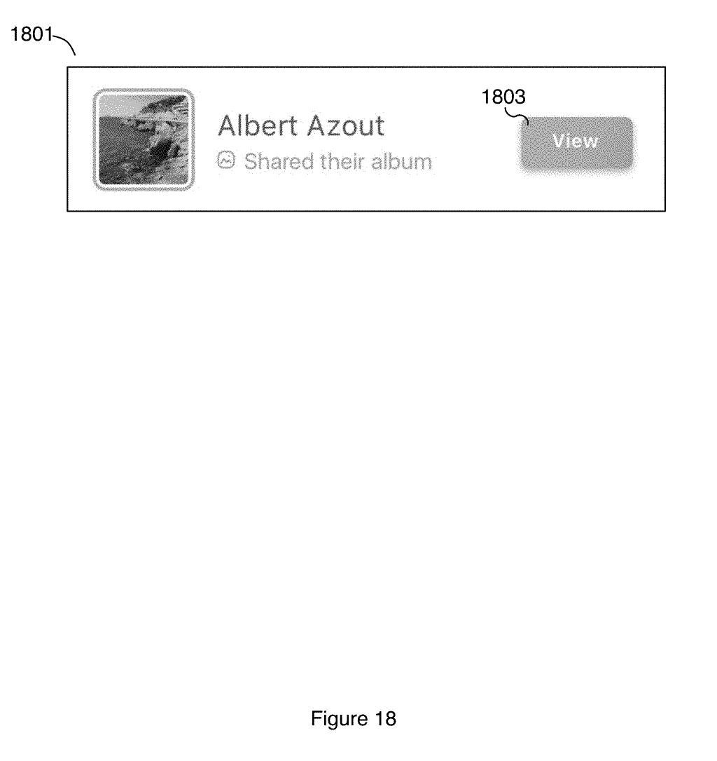

FIG. 18 is a diagram illustrating an embodiment of a user interface for the notification of shared media. In some embodiments, the user interface of FIG. 18 is displayed on clients 101, 103, and 105 of FIG. 1. In some embodiments, the diagram of FIG. 18 is implemented on clients 101, 103, and 105 of FIG. 1 based on digital media received from server 111 over network 107 of FIG. 1. In some embodiments, the digital media is digital media shared at 305 of FIG. 3. In some embodiments, the user interface of FIG. 18 is displayed when another user shares a media with the user at 305 of FIG. 3. User interface of FIG. 18 may also be presented to a user when another user shares media using the user interfaces of FIGS. 16 and FIGS. 17 and/or the share now functionality.

In the example shown in FIG. 18, user interface 1801 is a notification displayed by a device for browsing media. In some embodiments, user interface 1801 may be displayed in response to a reverse follow request. User interface 1801 includes view button 1803, and displays the name of the user who has recently shared media. In the example, user interface 1801 displays the text “Albert Azourt” and the message “Shared their album” to inform the user that a user named Albert Azourt has shared an album of digital media. Using view button 1803, the user may view the newly shared media and is presented with a user interface to view the shared media. In some embodiments, the user is then presented with one of the user interfaces from the user interfaces of FIGS. 11A, 11B, 11C, and 14. In some embodiments, user interface 1801 is a notification that runs as part of the operating system notification framework and selecting view button 1803 runs a media sharing application to view the newly shared media. In some embodiments, viewing the shared media involves the process described with respect to FIG. 8.

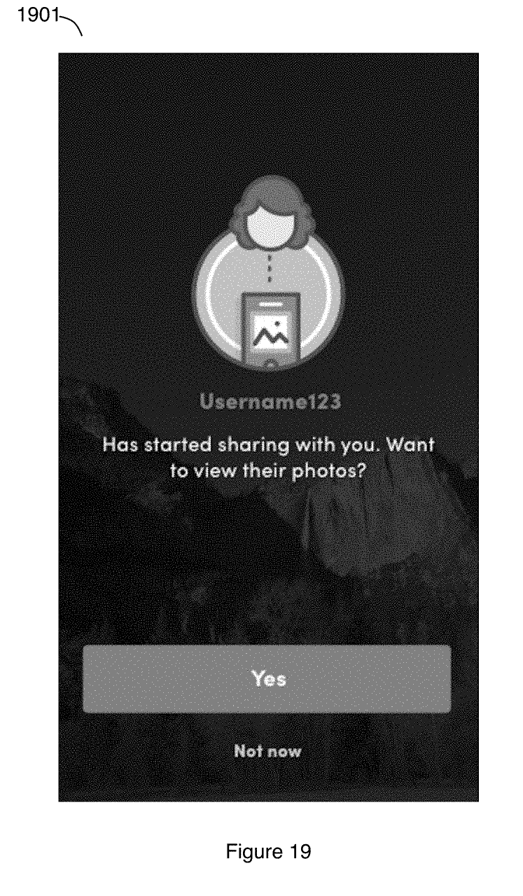

FIG. 19 is a diagram illustrating an embodiment of a user interface for the notification of shared media. In some embodiments, the user interface of FIG. 19 is displayed on clients 101, 103, and 105 of FIG. 1. In some embodiments, the diagram of FIG. 19 is implemented on clients 101, 103, and 105 of FIG. 1 based on digital media received from server 111 over network 107 of FIG. 1. In some embodiments, the digital media is digital media shared at 305 of FIG. 3. In some embodiments, the user interface of FIG. 19 is displayed when another user shares a media with the user at 305 of FIG. 3. User interface of FIG. 19 may also be presented to a user when another user shares media using the user interfaces of FIGS. 16 and FIGS. 17 and/or the share now functionality.

In the example shown in FIG. 19, user interface 1901 is a user interface window displayed by a device for browsing media. In some embodiments, user interface 1901 may be displayed in response to a reverse follow request. User interface 1901 includes a “Yes” button and a “Not now” button, and displays the name of the user who has recently shared media. In the example, user interface 1901 informs the user that another user has started sharing media with the current user and prompts the current user to view the shared media. In response to the prompt, the current user may select a “Yes” button to view the shared media or “Not now” button to not view the shared media. In the event the current user selects the “Yes” button, the current user is presented with a user interface to view the shared media. In some embodiments, the user is then presented with one of the user interfaces from the user interfaces in FIGS. 11A, 11B, 11C, and 14. In some embodiments, user interface 1901 is a window that is displayed as part of the operating system notification framework and selecting the “Yes” button runs a media sharing application to view the newly shared media. In some embodiments, viewing the shared media involves the process described with respect to FIG. 8.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving via a computer network at a device of a first user a digital media associated with a second user;
detecting that the device has displayed the digital media;
determining whether the device has displayed the digital media for at least a threshold amount of time; and
in an event the device has displayed the digital media for at least the threshold amount of time, providing an indication to the first user and sending a notification via the network, wherein the notification is utilized to provide to the second user, information associated with an interaction by the first user with the digital media.

2. The method of claim 1, wherein the indication is a gaze indication.

3. The method of claim 1, wherein the indication is a heat map indication.

4. The method of claim 1, wherein the indication includes a focal area.

5. The method of claim 1, wherein the threshold amount of time is based on consumption habits.

6. The method of claim 1, wherein the threshold amount of time is based on consumption habits of the first user.

7. The method of claim 1, wherein the threshold amount of time is based on properties of the device.

8. The method of claim 1, wherein the threshold amount of time is based on properties of the digital media.

9. The method of claim 1, wherein the threshold amount of time is configurable by the second user.

10. The method of claim 1, further comprising detecting a passive input of the first user.

11. The method of claim 10, wherein the passive input is based on eye tracking.

12. The method of claim 1, further comprising detecting an active input of the first user.

13. The method of claim 12, wherein the active input is associated with a focus area of the digital media.

14. The method of claim 12, wherein the active input corresponds to a zoom gesture.

15. The method of claim 12, wherein the active input corresponds to a selection gesture.

16. The method of claim 1, wherein the indication is a visual element overlaid on the digital media.

17. The method of claim 1, wherein providing the indication to the first user further comprises displaying a feedback user interface element.

18. A method, comprising:
receiving via a computer network at a device a plurality of feedback for a digital media;
detecting that the device has displayed the digital media;
displaying an indicator associated with the plurality of feedback;
receiving an input gesture;
determining an offset value associated with the input gesture; and
in response to the input gesture, displaying at least one of the plurality of feedback based on the offset value and a time value associated with the at least one of the plurality of feedback.

19. The method of claim 18, wherein displaying at least one of the plurality of feedback comprises overlaying the feedback and the time value associated with the feedback on the digital media.

20. A system, comprising:
a processor; and
a memory coupled with the processor, wherein the memory is configured to provide the processor with instructions which when executed cause the processor to:
receive via a computer network at a device of a first user a digital media associated with a second user;
detect that the device has displayed the digital media;
determine whether the device has displayed the digital media for at least a threshold amount of time; and
in an event the device has displayed the digital media for at least the threshold amount of time, provide an indication to the first user and send a notification via the network, wherein the notification is utilized to provide to the second user, information associated with an interaction by the first user with the digital media.
